(19) United States
(12) Patent Application Publication
(10) Pub. No.: US 2022/0035874 A1
(43) Pub. Date: Feb. 3, 2022

(54) USER GUIDE METHOD, GUIDE RETRIEVAL DEVICE, AND GUIDE RETRIEVAL METHOD

(71) Applicant: Olympus Corporation, Tokyo (JP)

(72) Inventors: Koichi SHINTANI, Tokyo (JP); Akira TANI, Sagamihara-shi (JP); Manabu ICHIKAWA, Tokyo (JP); Kensei ITO, Tokyo (JP); Osamu NONAKA, Sagamihara-shi (JP); Natsuko SATO, Tokyo (JP)

(21) Appl. No.: 17/346,114

(22) Filed: Jun. 11, 2021

(30) Foreign Application Priority Data
Jul. 28, 2020 (JP) 2020-127071

(51) Int. Cl. G06F 16/951; G06F 16/9535; G06F 16/9537; G06F 16/9538; G06F 16/906

(52) U.S. Cl. CPC G06F 16/951; G06F 16/9535; G06F 16/906; G06F 16/9538; G06F 16/9537

(57) ABSTRACT

A user guide method, comprising determining a reference area according to user behavior and target events the user is interested in, acquiring a reference target event heat map representing distribution of the target events within the reference area for a specified time point, and estimating conditions of a target event at a time when time has passed from the specified time, by referencing the reference target event heat map, and a database that shows chronological change of previous heat maps for the same or similar areas.

### CROSS-REFERENCE TO RELATED APPLICATIONS

Benefit is claimed, under 35 U.S.C. § 119, to the filing date of prior Japanese Patent Application No. 2020-127071 filed on Jul. 28, 2020. This application is expressly incorporated herein by reference. The scope of the present invention is not limited to any requirements of the specific embodiments described in the application.

### BACKGROUND OF THE INVENTION

### 1. Field of the Invention

The present invention relates to a user guide method, guide retrieval device, and guide retrieval method for providing guide information to a user based on information that has been obtained in time series within a specified range.

### 2. Description of the Related Art

Accompanying the development of network environments in recent years, various information is being posted on SNS (Social Networking Services). It has been proposed to provide various services by utilizing this information. For example, an information processing device that extracts experience information, that includes information relating to time or place, from test information input by a user, compares this experience information with experience information of other users, and extracts groups of users acknowledged to have commonality in experience information, is proposed in Japanese patent laid-open No. 2013-257761 (hereafter referred to as “patent publication 1”).

With patent publication 1 described above, user groups for which commonality of experience information is recognized are extracted using information relating to time or place. As a result of this it becomes possible to easily implement sharing of experiences. However, with patent publication 1, although information relating to time is used, there is no description whatsoever regarding predicting the future based on information that changes over time, and providing information to a user based on this prediction.

### SUMMARY OF THE INVENTION

The present invention provides a user guide method, for predicting change in physical object information at a specified position and assisting user behavior, and a guide retrieval device and guide retrieval method for retrieving guide information.

A user guide method of a first aspect of the present invention comprises determining a reference area according to user behavior and/or target events the user is interested in, acquiring a reference target event heat map representing distribution of the target events within the reference area for a specified time point, and estimating conditions of a target event at a time when time has passed from the specified time, by referencing the reference target event heat map, and a database that shows chronological change of previous heat maps for the same or similar areas.

A guide retrieval device of a second aspect of the present invention comprises a processor having an acquisition section, a chronological correlation determination section, and a retrieval section, wherein the acquisition section acquires distribution information of target events within a specified area that has been generated a plurality of different times, the chronological correlation determination section determines chronological correlations based on time change of patterns of distribution of the target events and continuity in trend of movement of a distribution pattern, using distribution information of objects within a specified area that has been acquired by the acquisition section, and the retrieval section retrieves guide information from a chronological correlation database that was obtained using determination results for the chronological correlation.

A guide retrieval method of a third aspect of the present invention comprises acquiring distribution information of target events in a specified position range that have been acquired in time series, determining chronological correlations of distribution information of the target events that have been acquired, and retrieving guide information from a chronological correlation database that was obtained using determination results for the chronological correlations.

### BRIEF DESCRIPTION OF THE DRAWINGS

FIG. 1A to FIG. 1D are drawings for describing approaches for showing guides to a user with one embodiment of the present invention, and in more detail FIG. 1A is a graph showing increase and decrease in numbers of patients, and FIG. 1B to FIG. 1D are congestion maps.

FIG. 2 is a flowchart showing operation of chronological change correlation determination, with one embodiment of the present invention.

FIG. 3 is a flowchart showing operation of reference heat map day determination, with one embodiment of the present invention.

FIG. 4 is a block diagram showing overall structure of a correlation database creation system of one embodiment of the present invention.

FIG. 5 is a drawing showing an example of predicting a time that is appropriate for a user to experience cherry blossom viewing on a recommended course, in the correlation database creation system of one embodiment of the present invention.

FIG. 6 is a flowchart showing operation of chronological change correlation DB creation, with one embodiment of the present invention.

FIG. 7 is a flowchart showing a modified example of operation of chronological change correlation DB creation, with one embodiment of the present invention.

FIG. 8 is a drawing showing an example of a heat map image that is stored in an event prediction DB, in the correlation database creation system of one embodiment of the present invention.

FIG. 9 is a flowchart showing operation for user advice, of one embodiment of the present invention.

FIG. 10A is a flowchart showing operation of specified event selection from user behavior, of one embodiment of the present invention. FIG. 10B is a drawing showing an example of selecting a specified event from user behavior, in a correlation database creation system of one embodiment of the present invention. FIG. 10C is a drawing showing another example of selecting a specified event from user behavior, in a correlation database creation system of one embodiment of the present invention.

FIG. 11A is a block diagram showing a case where deep learning is performed, as a chronological correlation determination section, in a correlation database creation system of one embodiment of the present invention. FIG. 11B is a block diagram showing an example of a case where “cherry”, “plum” and “data for two years ago” are used as input data, in a case of performing deep learning as the chronological correlation determination section, in a correlation database creation system of one embodiment of the present invention.

FIG. 12A is a block diagram showing an example of a case where a plurality of types of data are used as input data, in a case where deep learning is performed, as a chronological correlation determination section, in a correlation database creation system of one embodiment of the present invention. FIG. 12B is a drawing showing a case of performing division of input data into sub categories, in a case of performing deep learning, in a correlation database creation system of one embodiment of the present invention.

FIG. 13 is a flowchart showing operation of chronological change correlation learning, with one embodiment of the present invention.

FIG. 14 is a flowchart showing a modified example of operation of chronological change correlation learning, with one embodiment of the present invention.

FIG. 15 is a drawing showing an example of a heat map image relating to corrosion of steel that is stored in an event prediction DB, in the correlation database creation system of one embodiment of the present invention.

### DETAILED DESCRIPTION OF THE PREFERRED EMBODIMENTS

One embodiment of the present invention will be described in the following using the drawings. Description will first be given of predicting a heat map after the lapse of a predetermined time, by estimation of chronological correlations of heat maps acquired in time series. It should be noted that portions that have been written in time series can be information that has been acquired as chronological change, and are not required to be at fixed intervals.

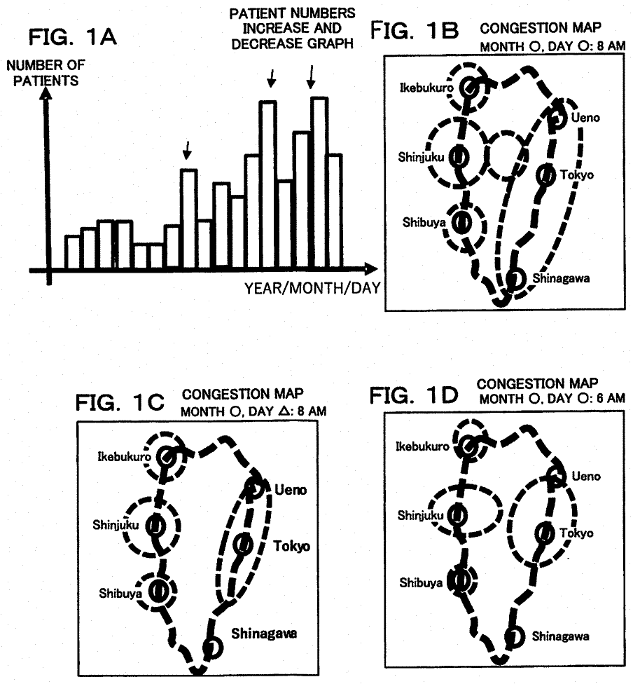

As shown in FIG. 1A, cases where individuals affected by a specified illness increase as time passes are known. It is generally difficult to determine what the main factors causing this increase are. In a case where an illness is localized, and is attributable to characteristics of the environment of a certain region, it is possible to take steps using procedures to prevent increase in affected individuals, by investigating characteristics of that environment and the life characteristics of the patients. However, in reality conditions in a region change due to various factors such as the seasons and the climate, and also affected individuals are not limited to remaining in one place and may appear at various locations, and will likely behave in accordance with their surroundings. As a result, there will be cases where people will encounter causes of illness without individuals being aware of it, and this itself may constitute causes of the illness.

The movement of people is thus deeply connected to illness infection, and this can also be said for problems such as accidents that commence with a falling accident, and thefts such as pickpocketing and loss (things that cannot be found) etc. There are many cases where the frequency of events increases due to people (or things, depending on the situation) being close together or crowded, or because of restrictions such as reduced freedom of movement due to the fact that people are crowded together. It is also easy for these types of problems to arise due to fatigue while being active, constraints on eating and excretion, difficulties in temperature adjustment etc. If it is an open air situation, there are also the effects of climate, and under conditions where people have mingled at the places they have visited, it is difficult to escape from these types of conditions.

Accordingly, if there is an infectious illness, it is easy to imagine that a community of people constitute one cause of that infectious illness. Places that are crowded with people are not the only cause of illness, and it is also easy to imagine the stresses of living under conditions with different constraints to normal living, such as worsening of allergies and heatstroke, and chronic diseases etc. causing various such illnesses. If it is possible to predict events such as these congestions, and avoid congested conditions, and take into consideration measures for handling problems caused by these conditions beforehand, it would be possible to prevent the above described types of issues with mind and body health, or with peaceful amenities, before they happen. It should be noted that although description is given here for crowded conditions mainly targeting people, events that are the subject of this application may also include distribution of plants and animals, and congestion of vehicles etc.

Accordingly, in a case such as where a number of patients suffering from a particular illness increases according to the day, as shown in FIG. 1A, the causes of that increase will not be discovered simply by individual patients being examined by individual doctors. In order to discover environmental factors that patients are unaware of, it is important to confirm whether specific environmental conditions are not attributable for each of respective days, in accordance with increase and decrease in patients. Differences in characteristics of individual behavior, and change in the environment, have been graphically shown on maps as a result of the proliferation of various portable terminals, various network associated terminals, and security systems in recent years, and it is has become possible to confirm these differences between them. Using a heat map that shows degrees of congestion and change etc. in colors, it is possible to easily confirm what type of conditions there are and in what ranges these conditions exist, using two dimensional patterns. At this time, it is preferable to grasp conditions by comparison etc. on maps that have been segmented into areas that substantially correspond to areas of activity of the patients shown in FIG. 1A. For example, it becomes easy to confirm whether or not congestion conditions of the specified routes such as in FIG. 1B and FIG. 1C, and the increase or decrease in patient numbers as in FIG. 1A, are associated, by comparing the two.

This type of pattern determination on a map makes consideration using information confirmation capability by means of eyesight, that people are good at it, simple. Also, at the same time, pattern determination on a map makes it possible to appropriate many advanced solutions that utilize images. For example, there is an increase in patients on days shown by the arrows in FIG. 1A, and if the days where there has been this increase in number of patients correspond to commuter rush hours on the specified dates shown in FIG. 1B, then it is safer to not have activity in areas in which congestion arises on a two-dimensional pattern, at least in time bands of conditions such as shown in FIG. 1B. It should be noted that at the time of these types of judgment, on the date and time shown in FIG. 1C there is not as much increase in patients as on the date and time in FIG. 1B.

However, before the conditions of FIG. 1B come about, a situation cannot be dealt with if it is not possible to make the above predictions. Therefore, a heat map for a time before the heat map show in FIG. 1B (for example, two hours before) is acquired, and if this heat map has conspicuous congestion conditions in this time band it would be good to predict that it will constitute a heat map such as shown in FIG. 1B. In this way, if prediction is possible, then in order to avoid problems that are likely to happen in conditions such as in FIG. 1B from two hours before (here, incidence of disease), this situation can be advised to the user as a prediction service. Also, with infections etc., symptoms occur and an outbreak is confirmed after the lapse of a predetermined time period from when congestion occurred, and statistics such as in FIG. 1A are compiled. Therefore, taking into consideration infection period etc. it is preferable to understand that there are differences in the conditions shown in FIG. 1C the condition shown in FIG. 1B.

To that end, whether or not similar trends having time differences can be found in difference between increase or decrease in patient numbers shown in FIG. 1A and the congestion patterns shown in FIG. 1B and FIG. 1C is confirmed, and if the result of this confirmation is that similar trends could be found, prediction becomes possible if time differences in which similar trends can be found are considered. Although units of days may be used in the case of predicting use of expressways and airports during holidays, or congestion of tourist spots etc., since hour units are preferable description will be given in the following where units for the purpose of prediction are in hours, depending on the scene. Also, it is not always necessary to avoid congestion conditions, and there is also a desire to visit places on extremely busy days. That is, not only are specified problems are avoided, it is also conversely made possible to provide guidance for popular spots from information on congestion.

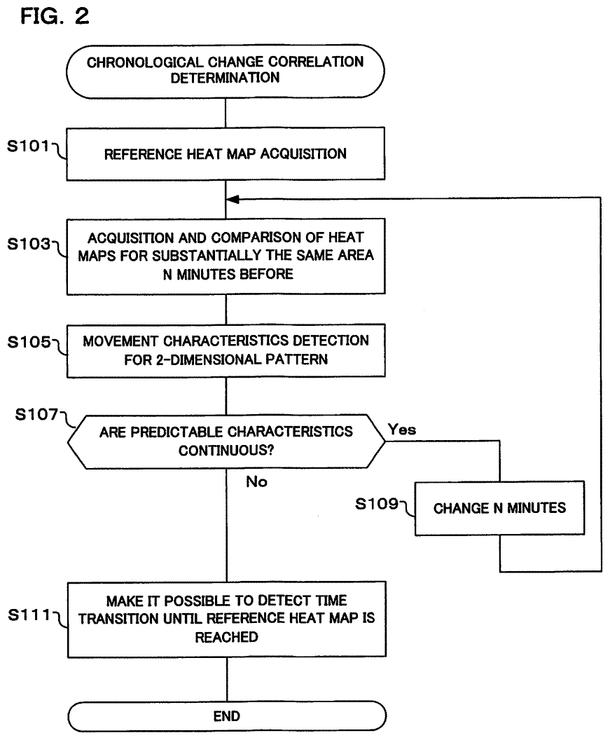

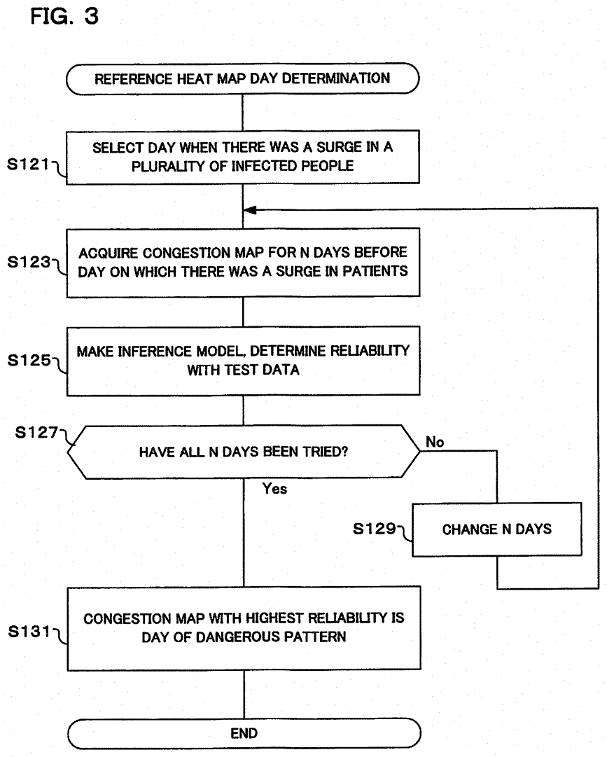

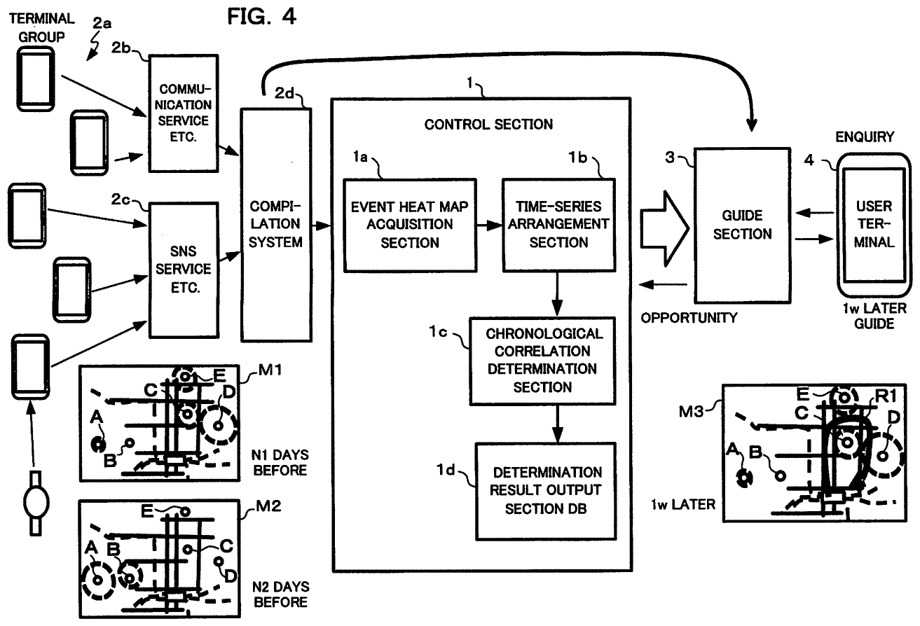

Next, description will be given of operation to determine when it will be possible to predict that a specified area will become congested, using the flowchart shown in FIG. 2. This flow can predict beforehand when conditions such as those of the congestion map as shown in FIG. 1B will come about. If congestion can be predicted beforehand, then a user can avoid problems and risks by avoiding areas that will become congested. This flow performs collection of information using an equivalent structure to the control section 1 of FIG. 4, which will be described later, and performs creation of a predictable database beforehand. Accordingly, a structure for executing the flow of FIG. 2 (the same applies to the flow of FIG. 3 which will be described later) may be achieved by suitably amending the control section 1 shown in FIG. 4, and so detailed description is omitted.

If the flow for chronological change correlation determination shown in FIG. 2 is commenced, the control section acquires a heat map (reference heat map) for at the time a problem occurs, in estimation areas (S101). For example, in a case where the user travels for business using public transport (including routes etc.) within the Tokyo metropolis, the control section sets subway train route maps and areas in which other routes exist based on reference areas in accordance with user behavior and target events the user is interested in. Once areas have been set, then as shown in FIG. 1B to FIG. 1D, for example, a reference heat map that has distribution information of target events at that specific time, for example, in FIG. 1B, at 8 am on day X of month Y, that are considered risky shown on an easily understandable map (with the example of FIG. 1B, a route map for a specified zone), is first acquired.

With the example shown in FIG. 2, a person is made the subject of analysis, but when analyzing distribution patterns for that target event (congestion of people) if a heat map is created that shows positions where objects that constitute the target event exist, and densities, as two-dimensional patterns and colors, it is also easy to intuitively understand for people looking at the heat map. When creating a heat map, it is possible to use various services on the Internet. In this case, information on time points (previous) where congestion has occurred should be collected. For example, by preparing usage history of electronic money used by respective traffic companies, usage performance of communication networks of portable terminals used by communications companies, usage performance or security information of surveillance camera networks, or news sites etc. that collect together these items of information, times, dates and locations are designated, and these items of information may be used.

In performing prediction of congestion etc., it is investigated whether or not there is correlation between heat maps at a predetermined time (reference time point, for example, month X day Y: 8 am shown in FIG. 1B) (for example, time point at which a problem occurred previously), and heat maps for a specified time before from a specified time point (for example, month X, day Y: 6 am in FIG. 1D), and whether a process until a heat map conditions for the specified time point is reached can be predicted may be determined based on this correlation. However, regarding whether or not it is possible to simply predict the state of FIG. 1B with only the information of FIG. 1D, for example, with this example there is a time difference of two hours, which means that events (people) constituting congestion patterns in respective maps will be completely replaced, and so even if a trend can be grasped, how the congestion pattern has changed over time will not be known. Put simply, in the event that there is this type of crowding at a specified time of a specified day, then subsequently crowding for a different time may be inferred from that, but in the flow shown in FIG. 2, determination is performed while also taking into consideration information on time between the two events.

Thus, in step S101 the control section determines reference areas in accordance user behavior and target events the user is interested in, and obtains a reference target event heat map showing distribution of target events within the reference area for specified time. Here, information of a specified area is being used, but topography of that area, buildings and roads existing in that area, etc. exert influence and constraints on the behavior of people (objects) themselves. For this reason information of a specified area includes abundant information that is different to object distribution of a simple plane. That is, the value of information is increased with such placement of roads and buildings etc. that constitute additional information.

If a reference heat map has been acquired, the control section next acquires a heat map for substantially the same area N minutes before, and compares the two (S103). Here, the control section acquires a heat map for a time difference (N minutes before) close to the time at which the reference heat map was acquired, for substantially the same area for which the reference heat map was acquired in step S101. This heat map and the reference heat map that was acquired in step S101 are compared. It should be noted that in this flow minute units have been used as N minutes before, but depending on the nature of the target event the time before may be expressed in units of seconds, units of hours, units of days, units of months, or units of years.

In this step S103, information of a specified area is being compared, but other topography, buildings and roads existing in that area, etc. exert influence and constraints on the behavior of people (objects) themselves. For this reason it becomes possible to perform comparison using abundant information that is different to object distribution of a simple plane. That is, the value of information handled by this embodiment is increased with various information on the placement of roads and buildings etc. within a specified area constituting additional information. A heat map includes arrangement information of environmental components that exert influence and constraint on chronological change in target events, such as topography, buildings and roads, in the reference area. Environmental components include, for example, flora and fauna including artifacts and structures, natural geography such as oceans, rivers, mountains, lakes and marshes, and trees that are inhabiting or growing in these areas. This means that a heat map has a meaning of more than coordinate information on a simple plane, and includes, for example, life-style and behavior patterns of people, and information reflecting tastes and preferences.

In particular, in a case of performing guidance for a person's behavior, there is information for factors that exert influence to affect, restrict or draw attention to the behavior of other people, and use of data that incorporates this information has a meaning of more than patterns that visualize distributions. It is not necessary to put precise locations of individual objects into a heat map, and information such as average distance between individuals, and density etc. for each area may be substituted. For example, a number of people caught within a screen for every location etc. may be totaled using information of surveillance cameras, vehicle mounted cameras etc., and in a case where data can only be collected discretely, supplementary use may be made of data that can be acquired nearby.

Next, the control section detects movement features of a two-dimensional pattern (S105). If two two-dimensional patterns are compared, there will be cases where portions constituting features of each two-dimensional pattern appear to be moving with time, so to speak. In this step, the control section extracts feature components from each two-dimensional pattern, and detects movement of the feature components.

If movement features of the two-dimensional patterns have been detected, next, the control section determines whether or not predictable features are continuing (S107). Here, the control section determines whether or not movement of the features that were detected in step S105 is continuous, and if the movement is continuing determines that change is predictable. For example, in a case where people move by means of transportation, gathering positions (positions where congestion occurs) are dependent on speed of a vehicle and speed of walking etc., and since these do not have a significant difference, if there are a few minutes the gathering positions will move as a mass in the same direction, making inference with comparatively high reliability possible.

If the result of determination in step S107 is that predictable features are continuing, the control section changes N minutes (S109). If the result of determination in step S107 is that features of the two-dimensional pattern continue from the reference time to N minutes before, the control section sets N minutes to a further extended time, and processing returns to step S103. The control section can repeat comparison of adjacent times by repeatedly executing steps S103 to S109, and, for a two-dimensional pattern that has been displayed on a heat map or on a map, whether or not there are symptoms of congestion etc. from how many hours before or how many minutes before, can be used to determine geometry and movement etc. on a map. It should be noted that in step S103, correlation with the reference heat map that was acquired in step S101 may be determined, but correlation may also be determined using heat maps at earlier time points that were acquired for comparison.

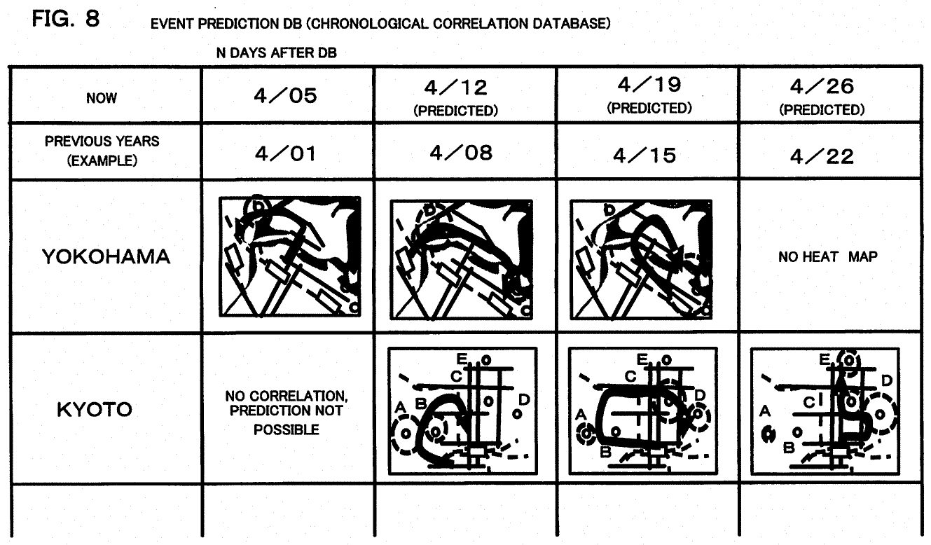

If the result of determination in step S107 is that predictable features are not continuing, the control section makes it possible to retrieve a time transition leading to a reference heat map (S111). As was described previously, in a case where the determination of step S107 is Yes and steps S103 to S109 are performed repeatedly, there is continuity in features of the two-dimensional pattern, and prediction is possible. However, if the result of determination in step S107 is No, namely that there is no continuity in the features of the two-dimensional pattern, and conditions are such that prediction is not possible, in step S111 the control section performs arrangement to make it possible to retrieve relationships between heat maps and time transition until a time when it can be considered that prediction is possible. As a method of performing management to make relationships retrievable, it is assumed, for example, to create a database such as shown in FIG. 8, which will be described later. If organization to make time transition of a heat map retrieval has been performed in step S111, this flow is terminated.

If a database for time transition of a heat map is created in this way, it is possible to reference how a bit map in a database that is similar to a current bit map has changed in a table, and it becomes possible to display, present and output retrieval results quickly. In this case acquisition of the current heat map is performed from a service administering institution, and if the heat map that has been acquired is compared with a heat map that is stored in the database with determination of differences by means of, for example, similar image retrieval, or feature comparison, it is possible to understand what previous conditions are resembled, and to determine an event that is likely to occur at what time in the future.

That is, a method has been described whereby, using this flow, reference areas corresponding to user behavior and target events they are interested in are determined, conditions of the target events for a point in time when time has elapsed from a specified time are estimated by acquiring a reference target event heat map showing distribution of target events within the reference area for a specified point in time, and a user is guided based on this estimation. In this estimation, a database that shows previous change over time of the reference target event heat map, and heat maps of the same or similar areas, is utilized. In this case, the database may be classified in more detail, and information that has been classified may be additionally retrieved. For example, with similar heat maps, there is a possibility of erroneous determination as to is it an increasing trend or is it a decreasing trend, and so as other information the season, day of the week, time etc. is referenced so as not to confuse a commuter congestion heat map for 6 am on a weekday with a returning home congestion heat map for 6 am in the evening. Also, in performing estimation, in a case where an event and climate at that time have an effect, an accurate database that has events and climate etc. added may also be used. Also, in order to determine directivity of increase or decrease, information on increase and decrease at a plurality of time points etc. may be added, and it is also possible to use heat maps for a plurality of time points.

It should be noted that although information for morning may appear similar at a glance, in actual fact at the time of returning home, features such as leaving the workplace together with colleagues, and differences in behavior such as returning home by circuitous routes appear in a heat map, and there are also cases where it is possible to determine whether it is morning or evening etc. using only a heat map. Also, with this proposal, since information for a plurality of areas is used, there are naturally effects and constraints placed on people's behavior by buildings and roads existing there themselves. As a result of this, these patterns themselves have countless additional information even if no additional information has been provided.

Also, even if appearance of transitions from a heat map is not managed in advance in a database, previous similar heat maps can be searched for instantaneously, and what will happen with the current heat map may be determined with reference to transitions at that time. The steps for determining a heat map can be omitted, and whether or not the behavior is safe, or if there are any dangerous conditions in the area, may be in the form of direct guidance.

Also, referencing a database and issuing guidance is not particularly necessary, and a user may be guided by utilizing AI etc. A method is considered where a heat map close to current conditions is retrieved by a heat map representing previous events, and inference is performed using an inference model that has been learned by searching for what kind of transitions have been obtained using that heat map.

For example, a reference area is determined, a reference target event heat map that shows distribution of specified target events within the reference are as a specified point in time is acquired, an inference model that has been obtained by learning using previous change over time of target events, or an inference model that has been acquired using results of having learned using training data for a plurality of previous time points of target events, is prepared, and user guiding may be performed based on results of having performed inference using this inference model. It is possible to create a guide so as to infer conditions of target events for a point in time after time has elapsed from a specified time point. This inference model may be created by performing machine learning or deep learning using training data that has been subjected to annotation as to whether or not dangerous congestion has been reached at respective N times, in many heat maps, from previous data, for example. It is possible to output guidance such as “Danger after N hours” by inputting a current heat map to this inference model.

There is also a method whereby a heat map for the current time point is subjected to annotation using a maximum congestion heat map for that day. In this way it is possible to infer whether or not a heat map for that day suggests danger. Also, if a heat map is acquired, then training data created by subjecting time at which that heat map was acquired (8 am, or 9 am) to annotation, and learning performed using this training data, an inference model for change patterns is obtained. If a heat map is input to this inference model it is possible to predict the next peak. Regarding whether or not the day on which this heat map was created is a day on which it seems that a number of people infected increased, if training data is created by performing annotation using only options such as “safe” or “dangerous”, and an inference model generated by performing learning using this training data, it is possible to infer at least whether that day is safe or dangerous by inputting a current heat map to this inference model.

It should be noted that in the flow shown in FIG. 2, for change over time of areas and colors of two-dimensional patterns appearing within a heat map (also called a heat map that combines a map and a pattern), movement features are determined by comparing maps of adjacent times. However, movement features may also be determined using methods other than those described above. For example, continuity (degree of coincidence and predictability) etc. of directivity of movement (the fact that directivity has been written instead of direction is because consideration is given not strictly to movement direction, but also to stoppages and speed etc.) may be determined by detecting barycentric position of a two-dimensional pattern, change for each time of barycentric position of a two-dimensional pattern in which information on color has also been weighted as required, and a degree of coincidence of speed and direction of that change. It is possible to predict the future by extending this continuity. This type of determination of appearance change of patterns on maps can be said to be determination of sequential correlation relationships. Since description can also be given for degree of coincidence and predictability, chronological correlation may be replaced by predictability.

Also, in the flow of FIG. 2, description has been given of a method in which heat maps for different times are compared, and whether or not there are analogous features in that pattern, and whether there is relevance in change before and after, etc., is obtained. If difference between different times is small, it should be recognized that there are similar patterns in both maps that have been compared, and only slight variations and area changes are recognized. Accordingly, by finding corresponding patterns, it becomes possible to easily express these changes in appearance as barycentric position (expressed as a motion vector), area and other numerical values. Also, if these changes in appearance are understood in advance, patterns that appear maintain similar shapes, and area etc. (also including density information if it is a heat map) is maintained, then characteristics of pattern movement will be understood even over a wide time difference, and it will also become possible to predict future pattern change (movement, and area and density etc.) from these movement characteristics.

However, it is conceivable that from how long before prediction is possible will be different depending on the conditions. If there is a time in which the same group moves on the same map, there is a possibility that prediction will be comparatively simple. In particular, it is easy to predict whether or not there will be congestion at a station or the like where a plurality of groups have gathered are heading in the same direction. For example, means of transportation are stopped and trains curtailed etc. depending on the weather, such as it being windy or snowing. In this case, there will be cases where it will no longer be possible to accommodate people at a station, but currently there is no service to provide this type of prediction. However, if it is possible to predict congestion etc. a few minutes or a few hours before utilizing the approaches of this embodiment, the user can take various measures to avoid problems, such as changing the station they transfer at, changing the station they get off at, or not stopping the train as a station, etc.

In a case of heading towards a station that has packed trains on two lines at the same time also, congestion at that station will change depending on how many people are getting off trains, or how many people are still on the trains. Because of this, if the chronological correlation determination section, that determines gatherings of objects (people here) and discrete time shifts (temporal correlations), determines chronological correlation based on trend in change over time of overlapping of a plurality of patterns for distribution of target events (such as number of people who are coming along a plurality of routes) using distribution information (such as congestion of a packed train) for target events within a specified area, it is possible to predict dangerous levels of congestion at that station.

Prediction as to whether the state in FIG. 1D described previously can reach the state in FIG. 1B is difficult with only these two differences. However, if heat maps that were acquired by dividing the time between the states of FIG. 1D and FIG. 1B more finely are compared, then at adjacent times it is possible to find similar patterns, and if pattern changes are successively followed it will be known how long it will take to reach a problematic heat map. The flowchart shown in FIG. 2 is in line with this type of approach. That is, FIG. 2 shows a case where how previous congestion conditions arose is traced back from previous data, and from what point in time symptoms appeared is investigated. With the flow of FIG. 2, in order to predict rush hour congestion etc. relevancy of problem heat map information and heat map information that is before that in units of minutes, is determined.

It should be noted that in a case of change in distribution of flora and fauna that changes gradually with the seasons, tracing back may be in units of “date”. In this case also, differences in heat maps for adjacent dates and times are few, such as there being hardly any change in heat maps for adjacent previous days, and on the day before, not much change from the previous day, but if the situation is traced back some days there is no longer any correlation, similarity, or association between heat maps.

Also, in the case of units of minutes, with 5 minute units and with 10 minute units people do not suddenly disappear from sections constituting objects at the center part of a map (with this meaning it is preferable to leave problem patterns as maps of central sections), which means that it is possible to determine correlations before and after. However, with finer time differences, apart from the fact that load is imposed and time is taken for computation, transitions of change in heat maps are easier to understand. A heat map is for performing processing such as mapping existence range of objects, displaying degree of gathering as area, and classifying density by color, as required, but coloring does not necessarily have to be performed. While a simple object existence position map would suffice, a heat map is easy to make into an image, and it is possible to enrich information by using color information. While the term used is a heat map, it may also be described as distribution information for target events. In this specification, depiction using patterns such as two dimensions, coloring, area etc. is described as a “heat map” which is easy to recognize for the human eyes and human brain, and also simplifies description. However, with computer processing such as AI, there may also be processing with information groups and data groups that are represented using representation that is different to that of a heat map.

However, a heat map, as well as utilizing the gathering of information logically and effectively, also ultimately requires presentation of information to people, which means that even with a computer data groups that can be moved into a heat map include abundant rational information. Color information is information that has been converted in conformity with visibility of people, but representation of information is not limited to “color”. Color at a specified location can enrich information because if feature quantities of that location are the same color, for example, information on a plurality of primary colors is used at the same location. Taking the same approach, a plurality of information may be embedded at the same location.

That is, the guide retrieval system of this application comprises a chronological correlation determination section, and it is possible to create a database (DB) for guide retrieval by determining chronological correlation of distribution information of target events in accordance with distribution information of target events that has been traced back in time, and overlapping trend and movement trend of distribution patterns, for distribution information of target events corresponding to guide information. Here, since a distribution pattern represents characteristics of object distribution on a map, the trend of overlapping mentioned above means that it is possible to predict occurrence of congestion and occurrence of interactions by determining, for example, how two patterns overlap with time shift. That is, by looking at changes in overlapping it will be understood whether these are simply increased in density, or whether phenomenon other than density, for example, dispersion, etc. have occurred, by the interaction between each of the environment of that location, and/or target objects. Appearance of these changes is useful in prediction of these distribution pattern changes for a future time. Changes in the way this type of overlapping occurs may also be more conceptually called simply change of pattern. Also, the above described movement trend is positional change over time while maintaining characteristics of patterns having area or density of sections indicating existence of objects, or overlapping of colors representing these objects, and degree of coincidence of movement directivity, or number and density of objects within a group representing particular object density states, or conditions of object distribution, represented as distributions on a map.

That is, the chronological correlation determination section determines chronological correlation using distribution information of target events within a specified area that has been acquired by the acquisition section, based on change over time of individual patterns (like outlines of islands) of distribution of target events (like islands) appearing in that specified area, and/or continuation of trend of movement of individual patterns of distribution (such as area and undulations of islands), and trend of change over time of overlapping of a plurality of target event distributions. In this way, appearance an overall area and congestion of a specified region can be understood as characteristics of temporal change. With interactions between individual patterns, situations within an area change and object congestion density etc. of specified regions within an area change, which means that condition prediction may be captured as results of trends of individual patterns, and may be treated as a whole.

Obviously chronological transitions in a heat map may be associated in a DB, and while tracing back is not absolutely necessary, in this case there is a possibility that a specified heat map in question will not be reached. It should be noted that a plurality of time change patterns may be acquired in accordance with origin and characteristics of an object and the environment, and chronological change correlation may be determined by classifying objects without grouping them together. That is, in a case where target events can be classified into a plurality of categories, the above described chronological correlation determination section may determine chronological correlation for each of the respective categories.

Also, as was described previously, environments having an effect within a specified area that has been fixed for a specified heat map, or within an area around that area, differ, and there are cases where there is an effect on movement of objects, such as temperature and humidity, and wind direction, topography, and structures such as street and rooms, etc. In this case, when determining time correlations, focus is placed on the form and center of gravity of events that have appeared as two-dimensional patterns, densities etc. of objects constituting events, and it may be determined whether positional displacement arising in accordance with time is a transition such that it is possible to predict the future, from previously to now. If this determination is not possible, objects may be classified and analyzed based on parameter differences etc. Also, the above described chronological correlation determination section may determine chronological correlation in accordance with event information for a specified area, and information on environment, and similarly to determination for every category described above, should determine the above described correlations by dividing into object groups moving towards or away from an event, object groups that have been affected by environment, etc.

Next, operation of reference heat map determination will be described using the flowchart shown in FIG. 3. In the flowchart shown in FIG. 2, in step S101 a heat map for the day a problem occurred is made a reference heat map, but there are cases where a causal relationship as to what type of conditions lead to problems is not known. Therefore, in the flow shown in FIG. 3, it is possible to designate date and time etc. of making a reference heat map. For example, it becomes possible to determine what kind of conditions led to an increase in number of affected patients such as was shown in FIG. 1A.

For example, FIG. 1A is a graph representing transitions of number of people infected with a specified disease in metropolitan areas of Japan, and in this graph peaks of increase in number of infected people for which there is no reason, or that is unclear, may be sporadic. As a cause of this, there is that cases can arise where infected people, and people who are not yet infected, come into contact with each other in specified institutions such as offices and hospitals etc. (regardless of whether or not there are rational symptoms). In this case, it is common to use means of transport when going to these institutions. Accordingly, congestion prediction for these institutions constitutes an effective information source, and subsequently it becomes possible to provide a user with guidance to avoid similar problems before they happen. Even if it is not possible to specify locations of those institutions themselves, it is possible to also find similar correlations from a density heat map and a public transport congestion map, such as shown in FIG. 1B.

If the flow for reference heat map day determination shown in FIG. 3 is commenced, a plurality of infected people surge days are selected (S121). Here, this is a step of finding days when there has been surge in the previously described number of infected people.

Next, congestion maps N days before each patient surge day are acquired (S123). There are also an infection incubation stage, a wait-and-see type of situation for patients themselves, and situations at the hospitals, and data such as shown in FIG. 1A is not immediately manifest as numerical information on days when there was actually infection, and so earlier congestion heat maps are acquired in this step S123. This applies to patients in metropolitan areas (Tokyo area in Japan), and areas of the heat map also correspond to the metropolitan area. Initially, a map for the previous day (N=1) may be used, but in a case where a specified incubation period is known, acquisition of the earlier heat maps in step S123 should start five days before.

Next, an inference model is created, and reliability of the inference model is determined using test data (S125). In step S121, if there are three days in which there is a surge in infected people, such as shown in FIG. 1A, for example, two patterns among these are made into training data, while the remaining pattern is made into test data, and an inference model may be created using a system and approach of deep learning. Position dependent congestion information of a heat map may be results calculated on a day by day basis, may be time of the greatest congestion on that day, or may conform to conditions of concern based on listening to patients.

Inference model creation in step S125 involves annotation of dangerous days, with a heat map for N days before as training data. Heat maps for other days may also be used for annotation, as other than dangerous days. The previously described test data is input to the inference model that has been obtained using this type of learning, and it is possible to determine reliability by looking at the degree of accuracy with which results for dangerous days are output.

If reliability of the inference model has been determined in step S125, it is next determined whether or not different variations on N days have all been tried (S127). For example, if N days are up to two weeks previously, whether or not processing of steps S123 and S125 has been performed is determined using data of that period. If the result of this determination is that N days have not all been tried, N days is changed (S129), processing returns to step S123, and the processing of steps S123 to S129 is repeatedly performed. For example, processing is repeated with data for up to two weeks before.

If the result of determination in step S127 is that N days have all been tried, a congestion map having the highest reliability among the N days is made a day having a dangerous pattern (S131). Steps S123 to S129 are repeatedly performed, and if processing has been repeated with data up to two weeks before it can be considered that a heat map for a day that can be considered to be the most infectious day exhibits the highest reliability. Accordingly, a heat map (congestion map) for a day when reliability was the highest, among results for reliability that was determined in step S125, can be considered to be a danger pattern having the highest level of danger, and it is possible to obtain the reference heat map of step S101 in FIG. 2. In this step, a date when there were many infected people is known. This itself constitutes useful information that is very useful also in research into relationships of days when an infection and its symptoms appeared.

The flow of FIG. 2 described previously is not in units of days, and an example has been described having been narrowed down to danger conditions for a specified time. However, in a case where a guide such as “Let's not go out tomorrow” is output, FIG. 2 may also be processing for day units. Also, in a case where, among days that showed a dangerous pattern, a more detailed time band is designated, as in step S101 in FIG. 2, in which time band a heat map is distinctive may be narrowed down by similar means to that shown in FIG. 3, and a heat map for a time band in which the congestion was heaviest that day may be made a reference heat map. Alternatively, within that day, a heat map of a pattern that is different to that of another day may be made a reference heat map.

An inference model that has been generated in step S125 of FIG. 3, and that also has high reliability, sets a heat map for N days to training data, performs annotation of dangerous days in that training data, and performs learning. As a result, if a current heat map is made input for inference, that inference model then constitutes an inference model for determining whether there could be a dangerous day on which there will be an increase in infected people (a day when there is an increase in the discovery of infected people compared to other days) some days later. If inference is performed using this inference model, prediction of danger is possible. Further, as has been described above, by executing the flow shown in FIG. 2 and FIG. 3, it becomes possible to provide technology that can advise a user so as to behave in such a way as to make infection less likely.

From the shape of a pattern (heat map) of a typical congestion map for a day on which a number of patients increases it can be considered that level of danger increases as that heat map is approached, and so advice may be given so as to keep way from that area. An approach can be considered whereby a smartphone outputs a notification of approaching that area, or displays using guidance for connections and routes, based on GPS information. Alternatively, in a case where the user appears to be approaching dangerous conditions they are alerted by displaying a prediction heat map on map information. Since dangerous areas change dynamically during time transition, technology to predict dangerous conditions in the future, as with this embodiment, is effective. In a case where a user enters a dangerous area, advice such as guidance to places with low congestion levels is effective. Information such as ventilation factors such as air-conditioning, evacuation passages, locations where hands can be washed such as washrooms and toilets, locations of medical and insurance facilities, and shops where it is possible to purchase masks and antiseptic solution, etc., may be attached to this advice. That is, when outputting advice, information that is separate from that area may also be used. Also, as general infection measures, alerts for locations that a lot of people touch, such as handrails, door knobs, toilets, and faucets etc. may be combined with the advice.

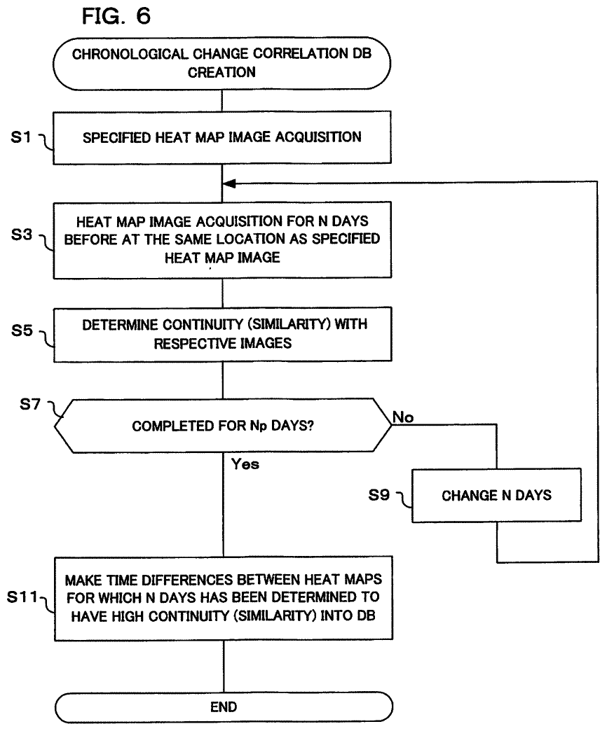

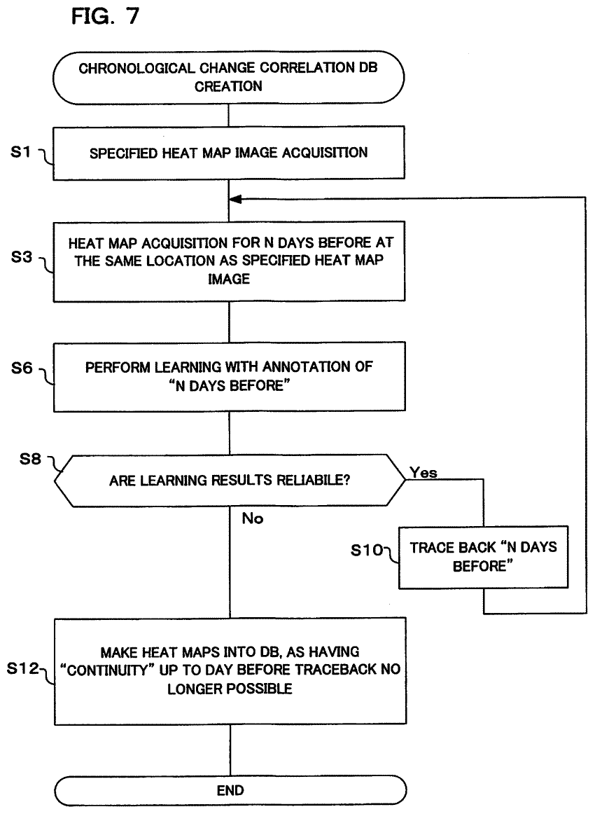

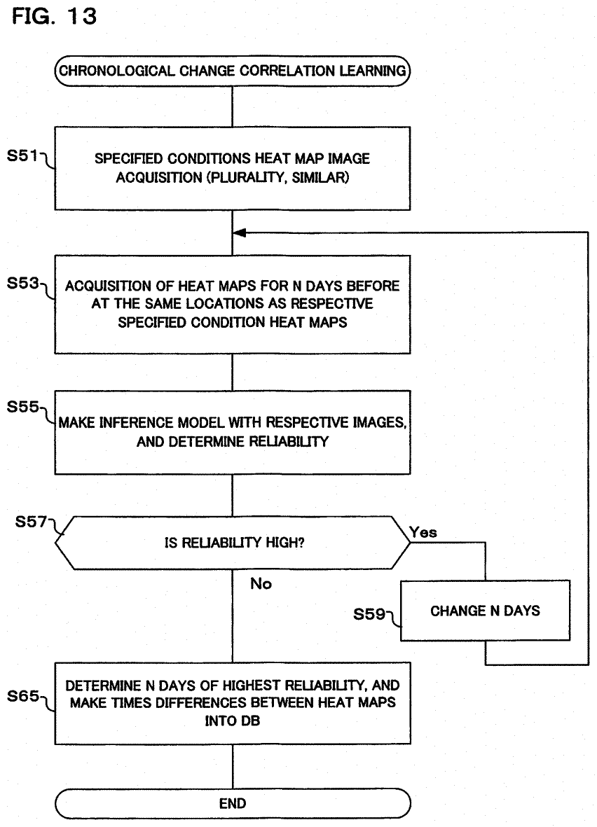

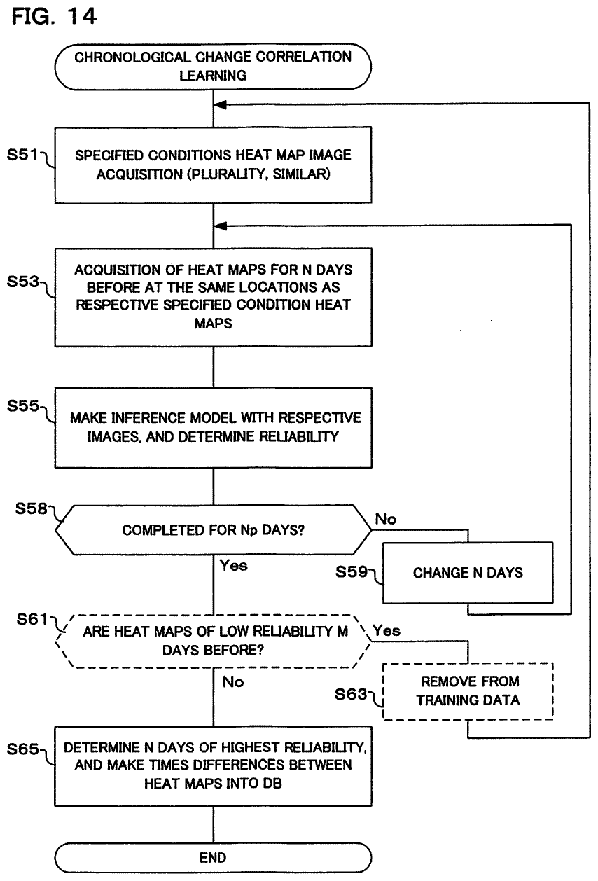

Next, a specific system and method for performing user advice will be described using FIG. 4 and after. With this embodiment, data from a portable information terminal or data that has been uploaded to the Internet is collected, time-series correlation of this data is determined, and a chronological correlation database is created using data within a range of high correlation (in other words a range in which there is continuity and similarity, or a range in which reliability of inference results is high) (refer, for example, to FIG. 6, FIG. 7, FIG. 8, FIG. 13, and FIG. 14). Since the chronological correlation database is created using data within a range of high correlation, it is possible to perform future prediction within this range, and this range constitutes limits of prediction.

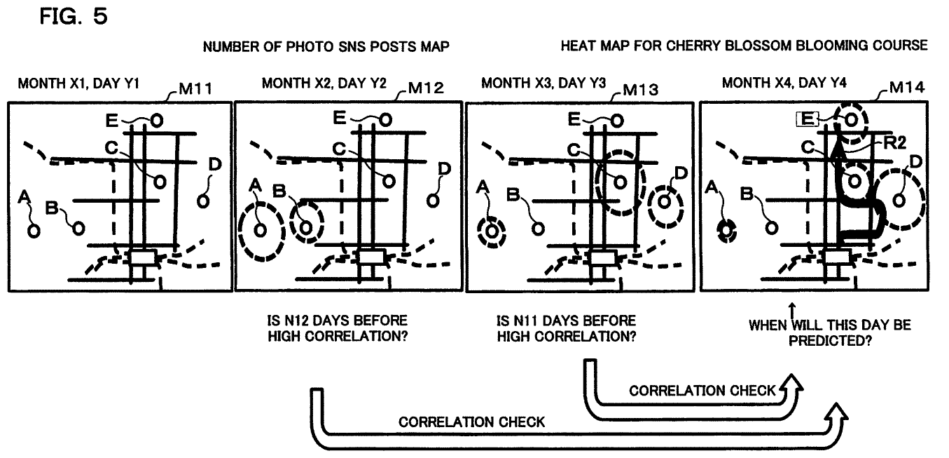

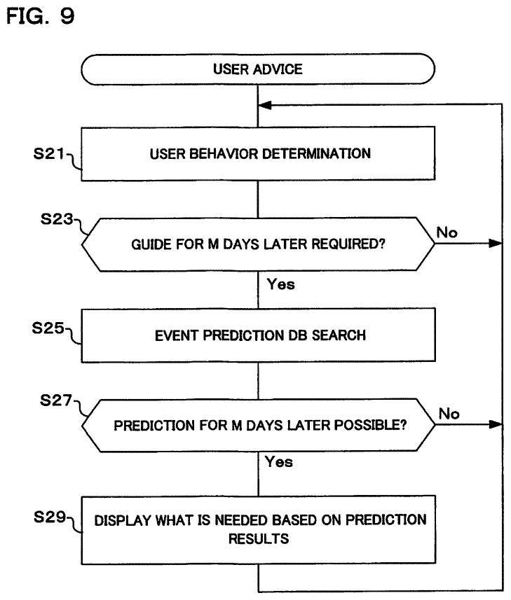

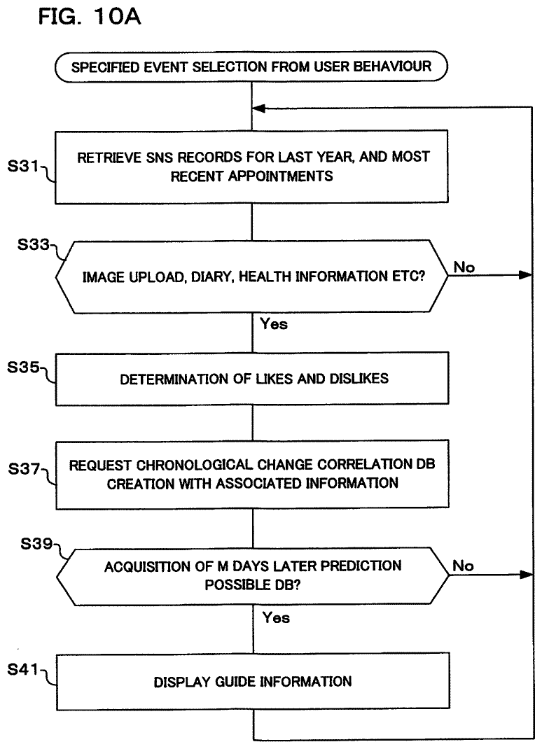

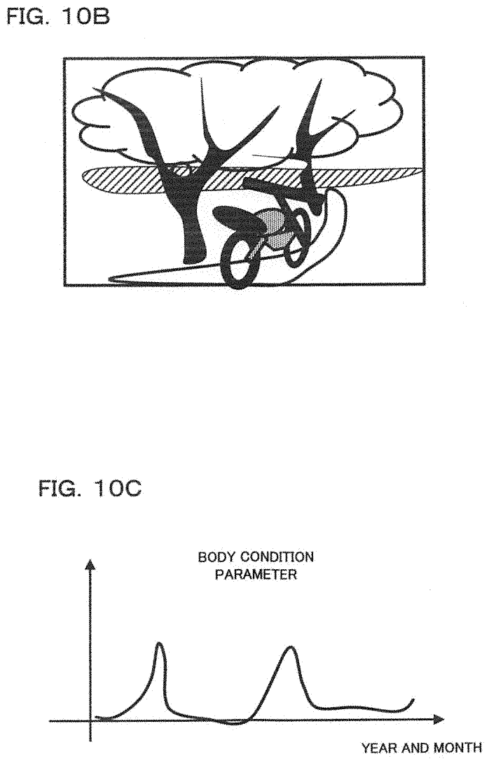

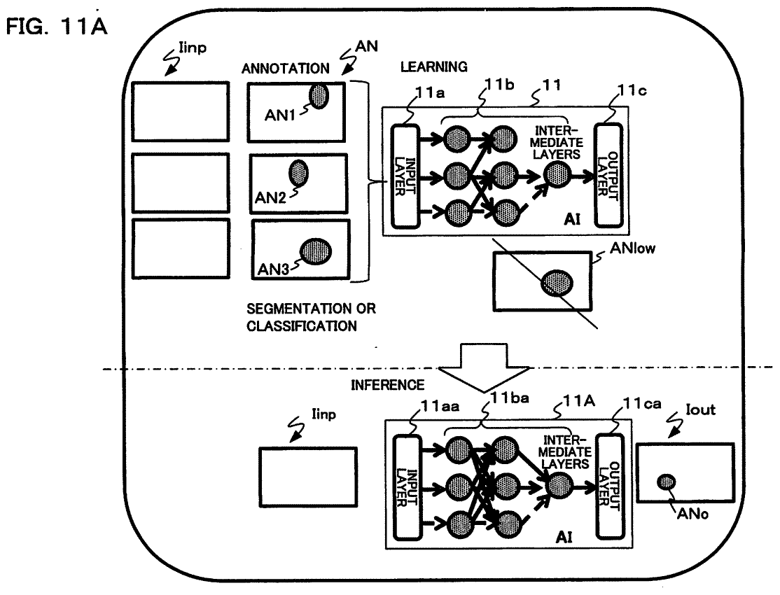

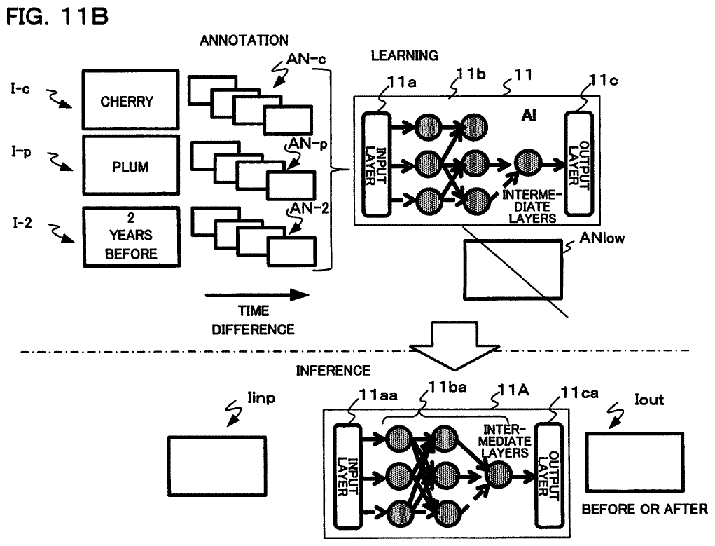

Also, with this embodiment, if a request is received from a user, or behavior of a user is determined, information on the needs of the user etc. is retrieved from the chronological correlation database that represents time from time change of time series heat maps, and object condition change (items capable of referencing correlation relationships for occurrence there, from chronological condition change (for example, corresponding to time change)), based on the request or results of determination regarding behavior, and provides this information to the user (refer, for example, to FIG. 9 and FIG. 10A). For example, it is possible to provide recommended routes for specified days later when cherry blossom viewing is good to the user (refer, for example, to map M13 in FIG. 4, and map M14 in FIG. 5). Also, an inference model is created utilizing the fact that there has been learning of this big data, and a chronological correlation database is created using this inference model (refer, for example, to FIG. 11A to FIG. 14).

Things that are currently happening are represented as “chronological correlations” with the meaning of resulting from correlation (causal association) between events that happened at times before that. This is because causal association, written as “causal correlation” is determined, and further represented on objective condition change patterns with weight attached. However, at a time when tangible reasons are clear, factors of causal associations may, or course, also be considered. In the case of making a database also, if there are factors such as causal associations having an effect, this may be handled by measures such as making a separate database or correcting a time axis etc. Either of objects a user focuses on, or events associated with the user's interests, may be made into a database, or both may be combined into a database.

FIG. 4 is a block diagram showing a correlation database creation system of one embodiment of this embodiment. A terminal group 2a is portable terminals held by various users, such as smartphones, mobile phones, tablets etc. This terminal group 2a is connected so as to be able to transmit information to a compilation system 2d by means of a communication service 2b or SNS service 2c. The compilation system 2d is arranged within a server, and includes at least a processor for performing compilation of information that has been gathered, and processing for management etc.

Each portable terminal of the terminal group 2a transmits information to the above described compilation system 2d, including current position information of that terminal, and time and date information. At that time, each portable terminal of the terminal group 2a is also capable of transmitting text information such as SNS and images etc. associated with main objects when creating the chronological correlation database. If there are images they are assumed to be photographs taken of objects, and as text information, if it is in cherry blossom season, for example, there is information showing blooming conditions of the cherry blossoms, such as “cherry blossom buds are swelling”, “cherry blossoms have flowered”, “cherry blossoms are fully open”, “cherry blossoms are falling” etc. Also, as images, in addition to images taken with cherry blossoms in the background and enlarged images of cherry blossoms, there is also handwriting showing blooming conditions of the cherry blossoms. These type of various objects themselves, and information representing conditions of events etc. (these may be expressed as target events), constitute big data, and various analysis becomes possible. The compilation system 2d is arranged on a server or the like, and compiles information such as has been described above from individual mobile terminals of the terminal group 2a.

Information that has been compiled by the compilation system 2d is transmitted to the control section 1. The control section 1 is arranged within a server or the like and has a processor that performs information management in accordance with programs that have been stored in the (storage medium). This processor functions as an acquisition section, chronological correlation determination section, and retrieval section. The server or the like in which the control section 1 is arranged may be the same as the above described compilation system 2d and may be different. An event heat map acquisition section 1a, time-series arrangement section 1b, chronological correlation determination section 1c, and determination results output section DB 1d are provided within the control section 1.

The event heat map acquisition section 1a acquires data for generating an event heat map. This event heat map is for displaying change in events that are related to objects that are a focus of interest of the user (may also be objects themselves) in a graph format (coordinates and conditions of objects or the like at those coordinates), in other words, a heat map is a graph on which independent values of two dimensional data (a matrix) are expressed as colors and light and shade. Representation is not limited to two-dimensional display, and may also be one dimensional display, for example, in FIG. 4 there may be one dimensional display that also considers congestion conditions on a specified road. By describing values corresponding to events at each point using colors etc. on a two-dimensional image such as a map, or on a three-dimensional image, it is possible to visualize that event. For example, with a heat map relating to cherry blossom blooming conditions, cherry blossom blooming conditions (for example, text such as 10 percent of buds blooming, in full bloom, images of cherry blossoms etc.) are analyzed for every area, and these cherry blossom blooming conditions may be understood at a glance using intensity of color, and magnitude of circle diameter etc., in accordance with number of contributions.

The event heat map acquisition section 1a functions as an acquisition section that acquires distribution information for target events within a specified area at a plurality of different times. The event heat map acquisition section 1a also functions as an acquisition section that acquires big data expressed in space within a specified area. The event heat map acquisition section 1a also functions as an acquisition section that acquires distribution information of target events within a specified positional range that has been obtained in time-series.

Data that has been acquired by the event heat map acquisition section 1a is output to the time-series arrangement section 1b. The time-series arrangement section 1b arranges data for every time series based on date and time information attached to data. For example, in a case where an event heat map has been generated in units of days, data that has been acquired from the event heat map acquisition section 1a is arranged in day units, and in a case where the event heat map has been generated in units of hours, data that has been acquired from the event heat map acquisition section 1a is arranged in units of hours, and a heat map image is generated.

Data that has been arranged by the time-series arrangement section 1b is output to the chronological correlation determination section 1c. The chronological correlation determination section 1c determines correlation relationships of data that has been arranged for every time series. Specifically, the chronological correlation determination section 1c determines correlation conditions of data that can be expressed on a map in a case where values corresponding to events have been associated with each point on a two-dimensional or three-dimensional map, and determines whether heat map images are similar, or if some time transition patterns include readable information (is there correlation).

The previously described target event distribution pattern is represented as a heat map that represents existing position and density of objects constituting target events as two-dimensional patterns and colors (refer, for example, to FIG. 1B to FIG. 1D, maps M1 to M3 in FIG. 4, and FIG. 5 and FIG. 8). The chronological correlation determination section determines chronological correlation in accordance with area, color, and time change of a two-dimensional pattern expressed within a heat map, and continuity of directivity of movement. This chronological correlation will be described later using maps M1 to M3 in FIG. 4, and FIG. 5.

The chronological correlation determination section 1c functions as a chronological correlation determination section that determines chronological correlation for distribution information of target event that has been acquired by the acquisition section. The chronological correlation determination section 1c functions as a chronological correlation determination section that determines chronological correlations based on change over time of a distribution pattern for target events, and/or continuity of trend of movement of a distribution pattern, using distribution information of target events within a specified area that has been acquired by the acquisition section.

The chronological correlation determination section determines chronological correlation based on trend of time change of overlapping of a plurality of patterns for distribution of target events, using distribution information for target events within a specified area that has been acquired by the acquisition section (refer, for example, to maps M1 to M3 in FIG. 4, and to FIG. 5 and FIG. 8). By determining this chronological correlation, it is possible to determine that, for example, congestion at Shinjuku station has changed, due to everyone in two commuter groups alighting the train at Shinjuku station, or carrying on while still on the train. That is, if characteristics of time change are determined, it is possible to estimate what will happen in the future. Conversely, characteristics of time change are akin to knowing what the future will become.

Also, the chronological correlation determination section determines chronological correlation of distribution information for target events taking into consideration the likes and dislikes of the user (refer, for example, to S35 in FIG. 10A). Likes and dislikes of the user are information that is obtained from history information that stores user behavior, or history information that stores relationships between health parameters and environment (refer to S35 in FIG. 10A).

The chronological correlation determination section determines chronological correlation of distribution information of target events in accordance with distribution information of target events that have been traced back in time, for distribution information of target event corresponding to guide information (refer to, for example, repeating of S103 to S109 in FIG. 2, repeating of S3 to S9 in FIG. 6, repeating of S3 to S10 in FIG. 7 and repeating of S53 to S59 in FIG. 13). Also, target event can be classified into a plurality of categories, and the chronological correlation determination section determines chronological correlation for every respective category (refer, for example, to FIG. 11A to FIG. 11B). The chronological correlation determination section determines chronological correlation in accordance with event information for a specified area, and environment information.

The chronological correlation determination section creates training data by performing annotation of time difference of distribution information of target events that have been traced back in time, on distribution information of target events corresponding to guide information, and determines continuity of distribution information of target events based on degree of reliability at the time learning was performed using this training data (refer, for example, to S123 to S129 in FIG. 3, S3 to S10 in FIG. 7, S53 to S59 in FIG. 13, and S53 to S63 in FIG. 14).

The chronological correlation determination section determines chronological correlation of distribution information of target events depending on whether overlapping of distribution information of target events that have been traced back in time is close to a predetermined specified proportion, for distribution information of target events corresponding to guide information. The chronological correlation determination section determines chronological correlation based on similarity of associated distribution information for comparatively close times within a plurality of times.

Determination results of the chronological correlation determination section 1c are output to the determination results output section DB 1d. The determination results output section DB 1d is a database, and makes correlation results that have been determined by the chronological correlation determination section 1c into a database for every day, for example, and stores this database. Time units used when collecting and storing information are changed in accordance with objects of interest, or speed of change of objects, or range of an area of interest. For example, if congestion conditions of people within the Tokyo Metropolis are a focus of interest time units may be made hours, and if the focus of interest is predicting swooping of domestic migratory birds within the country the units may be made units of a day or units of a week. If the determination results output section DB 1d receives an inquiry from a guide section 3, which will be described later, guide information according to objects for a time and date that have been designated by the guide section 3 are retrieved from the database, and this guide information is output. The determination results output section DB 1d can predict guide information according to objects at various intervals, such as predetermined hour intervals or predetermined day intervals, based on how heat map images stored in the database compare with current conditions.

The determination results output section DB 1d functions as a retrieval section that retrieves guide information from a chronological correlation database that has been obtained using determination results for chronological correlation. The retrieval section determines limits of prediction based on the chronological correlation database (refer, for example, to FIG. 8, S27 in FIG. 9, and S39 in FIG. 10A). Specifically, in this embodiment it is possible to determine limits of prediction when making guide information. In other words, it is possible to display that prediction is still not possible, but when prediction will become possible. Also, the retrieval section sets a range in which continuity or similarity of distribution information of target event is maintained, or a range in which reliability of inference results of correlation calculation is higher than a predetermined value, within a prediction range (refer, for example, to S5 and S11 in FIG. 6, S5 and S8 in FIG. 7, S57 and S65 in FIG. 13, and S65 in FIG. 14).

The retrieval section retrieves sightseeing routes for birds a specified day later, based on chronological correlation for target event distribution, on a map within a specified area (referred to M3 in FIG. 4, M14 in FIG. 5, etc.). The retrieval section determines user behavior, and retrieves guide information from the chronological correlation database based on this user behavior that has been determined (refer to S21 and S25 in FIG. 9, and S31, S33, and S39 in FIG. 10A, etc.). The determination results output section DB 1d also functions as an outputter that outputs guide information that has been retrieved by the retrieval section externally.

The guide section 3 issues a request for guide information to the determination results output section DB 1d, and the determination results output section DB 1db outputs guide information that has been retrieved from the database to the guide section 3. The guide section 3 is arranged within a server, and is a processor that executes information processing using a program. This server may be the same as the server having the control section 1, and may be a different server.

A user terminal 4 is capable of connection by means of wireless communication (including a wired communication network) etc. to the guide section 3. The user terminal 4 is a portable terminal held by various users, such as smartphones, mobile phones, tablets etc., and is similar to the terminal group 2a. If a user requests display of guide information using the user terminal 4, this request is transmitted to the guide section 3, and is further transmitted to the control section 1. Guide information that matches the request is retrieved from the determination results output section DB 1d of the control section 1. Guide information that has been retrieved is transmitted to the user terminal 4 by means of the guide section 3, and displayed on the user terminal 4.

For example, with the above described example of cherry blossoms, it is possible to visualize cherry blossom blooming conditions for a specified area by mapping cherry blossom blooming conditions based on date and time information, position information, and text information relating to cherry blossom blooming conditions onto a map. The map M1 in FIG. 4 is a heat map relating to cherry blossom blooming conditions N1 days before, and map M2 is a heat map relating to cherry blossom blooming conditions N2 days before. It should be noted that N1 days before and N2 days before mean N1 days before today and N2 days before today, and N1>N2. These heat maps can be created by the control section 1 based on information that has been collected by the compilation system 2d.

As will be understood from the heat maps M1 and M2, there is cherry blossom blooming information for areas A and B N2 days before, then, at N1 days before cherry blossom blooming information for areas A and B is reducing, while cherry blossom blooming information for areas C, D, and E is increasing. If the user wants to know a course when going to view cherry blossoms one week later, they operate the user terminal 4 to request display of a recommended course for cherry blossom viewing one week later, to the guide section 3. If the guide section 3 receives this request the user request is transmitted to the control section 1. Driven by this request, the control section 1 obtains areas that are good for cherry blossom viewing, and R1 for walking around these areas, based on cherry blossom blooming conditions for one week later, by performing chronological correlation processing using information that has been collected in time series, and outputs a cherry blossom viewing course based on this result to the guide section 3.

As shown in the map M3, a guide based on chronological correlation determination by the control section 1 is that areas in which cherry blossoms will be blooming one week later are C, D, and E, and it is determined that course R1 is suitable for going around this area. Guide information from the control section 1 is transmitted via the guide section 3 to the user terminal 4, and displayed on a monitor of the user terminal 4. It should be noted that with this example, the user has simply designated one week later as conditions for cherry blossom viewing, but conversely a request to designate an area, and display a period and course suitable for cherry blossom viewing in this area, may also be issued.

Next, description will be given, using FIG. 5, of an example of determining a period in which high reliability chronological correlation determination will be possible, and predicting when, within this period, will be a date that is most highly recommended for a user. In FIG. 5, maps M11 to M13 are examples of transitions of heat map images that have been created based on number of SNS posts that include photos, also including contribution position). Specifically, map M11 is a heat map image showing cherry blossom blooming conditions for month X1, day Y1, map M12 is a heat map image showing cherry blossom blooming conditions for month X2, day Y2, and map M13 is a heat map image showing cherry blossom blooming conditions for month X3, day Y3.

With the example shown in FIG. 5, the heat map has distribution of specified objects (here, specified objects are “blooming conditions” in contributed photographs) represented on a map (graph) using two-dimensional description, so as to make recollection easy from the word map. However, the heat map may be a one-dimensional graph if it represents congestion on a road etc., and may be a three-dimensional graph with further increased variables. If distribution patterns (appearance) of objects shown on coordinates are used, it becomes easy to predict change such as transition on coordinates, like images, so to speak.

With the example shown in FIG. 5 the heat map image M14 shows a route R2 going around areas C, D, E, and predicts a day when this route R2 will be a recommended course. The chronological correlation determination section 1c of the control section 1 calculates correlation between heat map image (in this drawing, fully open cherry blossoms in areas C, D, and E) M14 showing conditions of cherry blossom blooming shown on the recommended course, heat map image M11, heat map image M12 (N12 days before), and heat map image m13 (N11 days before). Once correlation has been calculated, with the example of FIG. 5, it is determined that correlations for heat map image M14 and heat map images M12 and M13 are high, but correlations for heat map image M14 and heat map image m11 are low. In this case, since correlation of heat map images is high from month X2 day Y2 to month X4 say T4, it is possible to perform prediction during that period using heat map images for that period.

Accordingly, in FIG. 5, if a predicted day is after N12 days before (month X2 day Y2), it can be predicted how many days after (month X4, day Y4) a day will have the heat map image M14. It should be noted that in FIG. 5 correlation check is performed for two heat map images, namely heat map images M12 and M13, with respect to heat map image M14, but a number of heat map images to be compared may obviously be three or more.

In this way, in the example shown in FIG. 5, the chronological correlation determination section 1c can determine when a heat map image will appear to be the same as a heat map image showing a recommended course based on correlation of heat map images that were created from previously information.

Next, operation of making a chronological change correlation DB (database) (method and program for creating the DB such as was shown in FIG. 5) will be described using the flowchart shown in FIG. 6. This flowchart creates a chronological change correlation DB that is used in order to predict a period in which a recommended heat map (or, with object distribution which there is a possibility the user will be bothered about, things that can be shown) comes about, as was shown in FIG. 5. This flow is executed by a processor, such as a CPU, controlling each section within the control section 1 in accordance with a program that has been stored in memory (not shown) within the control section 1.

Before specifically describing this flowchart, the approach to creating the chronological change correlation DB in the flow of FIG. 6 will be described. Even if there is chronological change, this flow depends on an approach whereby whether or not there are objects at specified times, and positions where those objects exist, are similar at adjacent times. That is, for things like flowers, conditions for blooming are similar even one day before and after, and with change such as buds being out, buds wilting, it is possible to take an approach whereby conditions exist so as to indicate or suggest that petals are open or closed. It is also possible to take an approach whereby, with congestion of people on a transport network, to an extent where movement arises between one station and another in minute units, similar conditions transition a little at a time in a heat map within an area having a suitable area.

Accordingly, little by little these minute units or day units are spread over 1 minute, 2 minutes, three minutes, . . . and 1 day, two days, three days, . . . , and if it is determined up to where similar conditions continue, it is possible to determine a limit to how far before it is possible to predict. That is, the distribution information acquisition section acquires distribution information of target events within a specified position (area) range that has been created at a plurality of different times (this corresponds to the heat map described above), and if there is a chronological correlation determination function to determine chronological correlation (rules for trend in change in degree of overlap and movement, by comparing a plurality of heat maps that have been obtained at different times) of distribution information of target events that have been acquired, based on determination results for chronological correlation, it becomes possible to create a chronological correlation database based on specified rules such as a heat map at this time is this, at the next time the heat map becomes this.

If there is a database that has been created in this way, whether, within that database, there are specified heat maps (heat maps showing congestion conditions for as specified area, for example) and heat maps showing similar patterns, is searched for, and if there are heat maps of similar patterns it is also possible to present as guidance as to what conditions will become from now on. Also, in the flow of FIG. 6, a guide to make it possible to show when conditions will be reached from now on is retrieved with a particular event (for example, distribution of flowers for cherry blossom viewing, weather conditions in the following example and after) as a reference.

The following two ideas are included in the above described approach. First, the approach is not limited to events that should be guided or are worthy of special mention, and creating a DB in advance tends to be wasted on problems of return on investment. Also, secondly, even if information is known after an event has finished, participation in later festivals cannot be done, or cannot be avoided. Therefore, what indications there were before an event worthy of special mention is for the purpose of inspecting correlations by tracing back in time. Also, obviously, ultimately there is tracing back until a time where no indications were permitted, but making information into a DB earlier becomes wasteful. Therefore, this type of method simplifies creation of a DB, and it becomes possible to make retrieval high-speed. That is, the chronological correlation determination section determines chronological correlation of distribution information of target events in accordance with whether or not time difference between distribution information for target events that have been traced back in time becomes a specified time difference, with respect to distribution information of target events corresponding to guide information. In the examples below, that is simply explained.

If the flow for chronological change correlation DB creation shown in FIG. 6 is commenced, first, heat map images are acquired. Here, the control section 1 acquires images of event heat maps for courses that will become recommended. For example, with the example shown in FIG. 5, there is a recommended course for cherry blossoms, as shown in heat map image M14. This specified heat map image may be created in response to a request from the user, and may be created automatically by the control section 1 based on various information. For example, a specified heat map image may be created by checking areas that the user wishes to tour around (areas C, D and E in FIG. 5) in a map that shows regions where users want to see cherry blossoms, such as heat map image M11 in FIG. 5. Also, the control section 1 may automatically create a specified heat map image as a result of the user inputting text data such as place names of areas they want to tour around. The user may input place names using speech instead of inputting place names using text data, and may also designate images to be uploaded to the Internet in the same manner.

Also, since it is desired to present a guide that expected conditions constituting a specified heat map that was acquired in step S1, the heat map of step S1 may also be written as a heat map for guide information. This flow creates a database for guidance, such as in FIG. 8, for example, by determining whether or not a time difference in which is it possible to predict, such as a few days before, becomes a specified time difference, for the purpose of predicting chronological correlation of distribution information for target events (here, cherry blossom blooming), for distribution information of target events corresponding to guide information, from distribution information of target events that have been traced back in time (“cherry blossom blooming” in the guide information heat map here). This is in order to be able to reference relationships between time differences that are expected and distribution information (for example, heat map images) of target events (cherry blossom viewing here).

If specified heat map images have been acquired, next, heat map images for the same location as the specified heat map image but N days before are acquired (S3). Here, the control section 1 acquires a heat map that was created N days prior from today, for specified heat map images that were acquired in step S1. Specifically, the acquisition section 1a collects information related to specified events, in a specified region, from the terminal group 2a by means of the compilation system 2d, and heat map images are created based on this information. These heat map images are images that show cherry blossom blooming conditions on a map that has been created, etc., based on information that has been transmitted by the users in each area, as shown in FIG. 4 and FIG. 5, for example. The heat map images are created in specified time units (for example units of months, units of days, units of hours, units of minutes etc.) based on time and date information. The control section 1 may also store heat map images that have been created in memory within the control section 1 for every date and time information, and may read out and use data that has been stored on other servers etc.

Next, determination of continuity (similarity) is performed (S5). Here, specific heat map images that were acquired in step S1 and heat map images for N days before that were acquired in step S3 are compared by the control section 1, and it is determined whether or not there is continuity (similarity). For example, with the example of FIG. 5, it is determined whether or not a number of contributions of specified heat map images and heat map images for N days before is similar for each of areas A to E.

It is next determined whether or not determination has been completed for a heat map for day Np (S7). Here, the determination performed in step S5 is determination based on whether or not determination has been completed for day Np that was determined in advance. This day Np that has been determined in advance may be appropriately set taking into consideration properties of a database that is generated, range of data that can be collected by the event heat map acquisition section 1a, etc.

If the result of determination in step S7 is that the determination for day Np has not been completed, day N is changed (S9). Here, day N determined in step S3 is changed, processing returns to S3, and the previously described operations are performed. By repeating steps S3 to S9 it is possible to determine continuity (similarity) of heat maps from the current point in time to day Np.

If the result of determination in step S7 is that determination has been completed for day Np, it is determined that day N is high continuity (similarity), and time differences between heat maps are made into a DB (S11). Since continuity (similarity) has been determined between the specified heat map images and the previous heat map images, in step S5, based on this determination result it is decided that day N has the highest continuity (similarity). It is determined that continuity or similarity is high if a difference between a number of contributions for respective areas in the heat map images is within a specified range.

If it has been determined in step S11 that continuity (similarity) is high, then it is possible to make heat map images into a DB with time differences between heat map images. It is possible to predict predetermined days when cherry blossom blooming conditions will match specified heat map images, from correlation between heat map images M12 and M13, and specified heat map image M14. The control section 1 also stores time differences between heat map images in a DB, and if there is an inquiry from the user it is possible to output guide information from the DB in accordance with the user request.

Next, description will be given of a modified example of operation of making the chronological change correlation DB (database) using the flowchart shown in FIG. 7. In the flow shown in FIG. 7 also, similarly to the flow shown in FIG. 6, it is possible to obtain whether or not there is correlation between a specified heat map (S1) that represents distribution information of target events at a specified time point on the map in an easy to understand manner, and a heat map a specified time before that specified time point (reference time point), whether or not there are similar things, and whether or not there is relevancy. However, this flow shown in FIG. 7 differs from the flow of FIG. 6 in that learning is performed by assigning annotation to a heat map for N days before, reliability of learning results is determined, and continuity of heat maps is determined from the result of this determination. This flow is executed by a processor, such as a CPU, controlling each section within the control section 1 in accordance with a program that has been stored in memory within the control section 1. Comparing the flowchart shown in FIG. 7 with the flowchart shown in FIG. 6, steps S5 to S11 in FIG. 6 are changed to steps S6 to S12 in FIG. 7, but other points are the same, and so description will center on the differences.

If the flow for chronological change correlation DB creation shown in FIG. 7 is commenced, first, specified heat map images are acquired (S1). Specified heat map images are images that depict distribution information of target events for a specified time point on a map in a way that is easy to understand. Specified heat map images may be created by the control section 1 based on a request from the user, similarly to the case of FIG. 6, or may be created by the control section setting a subject of the specified image based on text information that has been posted on SNS etc.

If specified heat map images have been acquired, next, heat map images for the same location as the specified heat map image but N days before are acquired (S3). Here, similarly to the case of FIG. 6, the control section 1 acquires a heat map that was created N day before today.

If heat map images N days before for the same location have been acquired, next, learning is performed with annotation of “N days before” having been performed (S6). Here, if specified heat map image data that was acquired in step S1 and heat map image data for N days before that was acquired in step S3 are input to an inference model, annotation such as “Day N” is affixed to create training data so that a result such as “N days” before is output from these data Machine learning is then performed using this training data.

A heat map is for performing processing such as mapping existence range of objects and displaying degree of gathering as area, and classifying density by color, as required, but coloring does not necessarily have to be performed. It is possible to simply have an object existence position map, but it is possible to enrich information with color information for ease of understanding, and so including these types of information is called a heat map. This may be written as distribution information of target events.

If learning has been performed in step S6, it is next determined whether or not learning results have reliability (S8). In the learning of step S6, determination as to whether or not an inference model of high reliability has been generated is described using an expression such as “Are learning results reliable?”. By trying input of test data to the inference model, by comparing what range that error falls in, or what type of test data there is in a specified error, with predetermined reference values, it can be judged whether reliability is good or bad. If it is a case where it is determined that reliability of inference is high as a result of the inference model performing this type of determination, it can be considered that heat map images are continuous up to that day, because there has been change capable of inferring future events.

If the result of determination in step S8 is that learning results are reliable, there is next trace back to “N days before” (S10). Here, there is change from “N days” in step S3 to days traced back by a specified number of days. If N days has been changed, processing returns to step S3 and steps S6 to S10 are repeated. Specifically, in step S10 similar inference models are created while changing N days (tracing back). If the learning results are high reliability, it is possible to prepare by arranging a table (database, DB) such as shown in FIG. 8.

Under various conditions in a case where there is the same heat map change after N days, it is easy to detect regularity of that change, but in step S10 switching of input of training data may be performed so as to output that type of result. It is inferred that correlation (chronological correlation, area and density of portions representing existence of objects, or overlapping or degree of coincidence of directivity of movement of colors representing these densities and portions) for two heat maps of different times is higher between two heat maps that are adjacent in time, than in a case where there are time differences that are too far apart, and there is a correct solution of “N days” of comparative high reliability.

Obviously “N days” in step S10 may also be “N minutes”. For example, in a case where people move using a mode of conveyance, a position where people are gathering (congestion occurring position) depends on, for example, speed of a train or speed of walking. Since there is not a significant difference between these, if there is a few minutes between them it can be inferred with comparatively high reliability that the positions of groups are moving in the same direction. Incidentally, data used in order to display the heat maps of FIG. 8 may be adopted as training data at the time of learning. It should be noted that although description has been given here of tracing back from a reference time point by N days (or N minutes), it is possible to trace back the reference time point itself sequentially and determine a time point that has been traced back and yields correlation, in other words, traceback of reference time point is repeatedly performed a little at a time from the initial reference day, traceback of N days (N minutes) from the reference day is finally determined, and in step S12 a database for guiding may be made.

If the result of determination in step S8 is that the learning results are not reliable, heat maps are made into a DB setting that until a day before traceback could not be performed has “continuity (S12). In a case where processing is executed by repeating steps S3 to S9, then since results of having performed learning using specified heat map images of step S1 and previous heat map images for N days before that have been read out in step S3 have reliability, it is a case where it has been determined that there is continuity between both images. In a case where continuity has been established, there is a possibility of predicting blooming conditions, such as a day when cherry blossoms are in full bloom at the time that both of those images were acquired. Conversely in a case where continuity is not established heat map images do not have reliability and are unsuitable for prediction. It should be noted that even if there is continuity there may be cases where continuity is temporarily broken. Therefore, even if it is determined that there is no continuity, determination of reliability may be performed again once or a plurality of times afterwards.

In step S12, the control section 1 stores heat map images that have been determined as being continuous in memory as a DB. In a case where there has been a request for provision of guide information from a user terminal 4 etc., the control section 1 reads out the most suitable heat map image from the DB in accordance with the guide information that has been requested, transmits this image to the user terminal 4, and displays the image (refer, for example, to the flowchart of FIG. 9). In a time range in which continuity is not established, a time when it is possible to provide guide information may be transmitted to the user terminal 4 based on a range that has been stored.

It should be noted that cherry blossoms in full bloom conditions are influenced by the climate for that year etc. Therefore, a heat map image for a particular year may be predicted by taking into consideration the climate etc. of that year, in a heat map image based on previous full bloom conditions.

In the flow shown in FIG. 7, it is possible to obtain whether or not there is correlation between a specified heat map (refer to S1) that represents distribution information of target events at a specified time point on the map in an easy to understand manner, and a heat map (refer to S3) a specified time before that specified time point (reference time point), whether or not there are similar things, and whether or not there is relevancy.

If there is change in distribution of flora and fauna that changes gradually with the seasons, if trace back is performed in units of “day of the month” shown here, differences between heat maps that are adjacent in time will be slight, such as there will be hardly any change the day before, and from the day before that there will be not be much change. However, since there is no longer any correlation, similarity, or association between heat maps if they have been traced back by a number of days, then for a heat map N days before that was obtained in step S3 there will be a result such as no reliability in step S8 if there is trace back by a few days. However, up until determination that there is not reliability there will be heat maps of high relevancy that can be predicted, and so until N days before when there is reliability, it can be considered that a specified heat map that was obtained in step S1 is predictable.

With this embodiment, there has been remarkable growth and development, and deep learning approaches are being used that are excellent in terms of “finding features from within data that humans cannot find”. For the purpose of this learning a specified heat map (reference heat map) is prepared in step S1, and further heat maps for N days prior are prepared for each respective reference heat map, so as to create an inference model by performing annotation of “N days before”. If learning is performed while removing heat maps having different trends from the training data, an inference model can be obtained for inference of respective time differences from two heat maps as “N days”. It should be noted that as a specified heat map, similar heat maps for other years at that location, and similar heat maps for locations with similar topography, namely, heat maps which have similar object distribution within maps that have been divided in similar distance ranges, may be prepared.

That is, with the guide retrieval system of this embodiment there is a chronological correlation determination section, and it is possible to create a database (DB) for a guide retrieval device by determining chronological correlation of distribution information of target events in accordance with distribution information of target events that have been traced back in time, and overlapping trend and movement trend of distribution patterns (area and density of section showing existence of objects, or overlapping of colors representing those areas and densities and degree of coincidence of directivity of movement), for distribution information of target events corresponding to guide information. Obviously only heat map transitions for heat maps that are chronologically before and after each other should be associated in a DB, and so while tracing back is not absolutely necessary, in this case there is a possibility that a specified heat map in question will not be reached. It should be noted that a plurality of time change patterns may be acquired in accordance with origin and characteristics of an object and the environment, and so chronological change correlation may be determined by classifying objects without grouping them together. That is, in a case where the chronological correlation determination section is capable of classifying target events into a plurality of categories, chronological correlation may be determined for each of the respective categories.

Also, as was described previously, environments having an effect within a specified area that has been fixed for a specified heat map, or within an area in that range, differ, and there are cases where there is an effect on movement of objects, such as temperature and humidity, and wind direction, topography, and structures such as street and rooms, etc. In this embodiment, in determining time correlations, focus is placed on the form and center of gravity of events that have appeared as two-dimensional patterns, and densities etc. of objects constituting the events, and it is determined whether positional displacement arising in accordance with time is a transition such that it is possible to predict the future, from previous to that, to now. However, in a case where it is not possible to detect transition, analysis may be performed by classifying objects by difference in parameters etc. Also, the chronological correlation determination section may determine chronological correlation in accordance with event information for a specified area, and information on environment, and similarly, should determine the above described correlations by dividing into object groups moving towards or away from an event, or object groups that have been affected by environment, etc.

FIG. 8 shows an example of heat map image transition stored in an event predictions database created using the flowcharts of FIG. 6 and FIG. 7. With the example of the heat maps of FIG. 8, the heat maps have distribution of specified objects (here, replaced with “blooming conditions” in contributed photographs) represented on a map (graph) using two-dimensional description, so as to make recollection easy from the word map. However, without being limited to two-dimensional representation, the heat map may be a one-dimensional graph if it represents congestion of specified objects on a road etc., and may be a three-dimensional graph with further increased variables. If distribution patterns (appearance) of objects shown on coordinates are used, it becomes easy to predict change such as transition on those coordinates, like images, so to speak. The example of the database for guiding as has been illustrated is able to mutually reference and match relationships between distribution information (for example, heat map images) of target events (cherry blossom blooming here) and target events that have a redetermined time difference.

In FIG. 8 place names (for example, Yokohama, Kyoto) are shown in the horizontal axis direction, and date is shown in the vertical axis direction. FIG. 8 is a heat map image showing cherry blossom blooming conditions, similarly to FIG. 5. Within the dates, 4/5 in the “Today” field is the date for today, (April 5th), while 4/12, 4/19, and 4/26 are predicted dates in the future. Also, 4/01 in the “Last Year (example)” field, shows that April 5th for this year is the same as the heat map image for April 1st the year before.

First, it is made possible to perform prediction using the DB by understanding the current situation. After having determined a specified area that corresponds to user behavior and target events the user is interested in, a target event heat map (reference target event heat map) showing distribution of target events within a specified area at a specified point in time is acquired. Alternatively, information itself in the form of direct data may be acquired, for example, a request may be issued to an external investigation service so as to gather current information, and a map may be created by gathering meaningful items themselves from big data (information such that it is possible to predict objects and events of interest after a specified time). Also, it is not strictly necessary to be at the time point of a specified heat map, and a reference target event heat map may be made using a map that was possible before that instead. At the current time point, if there is data for April 6th, or April 5th, it will be understood that the approach to being able to predict up until April 19th in Yokohama will be as described in the following.

Description will be given using a DB for Yokohama people, considering that a Yokohama guide will be useful for users interested in taking pictures at Yokohama locations. It is predicted that on April 12th of this year, a heat map image will become the same as a heat map image for April 8th the year before, and that on April 19th of this year, a heat map image will become the same as a heat map image for April 15th the year before. Since, in Yokohama, there are no heat map images that have continuity (similarity), prediction is not possible.

In this may, conditions for target events at a time point that is after a specified time point are estimated by referencing a database that shows chronological change of heat maps of similar areas (Yokohama in this description) to those of a target event heat map (here for Yokohama on April 5th), and a user guide may be output based on this estimation. It should be noted that even in the case of being far away from a specified area where prediction is not at all possible, for a user who wants to experience cherry blossom blooming after going to take pictures at that place, if there is a DB for Kyoto, for example, guidance may be output in accordance with this DB.

Also, in a case of being too early, it is possible to output a guide such as, for example, “Prediction is not possible for April 6th, prediction will become possible if you wait a little longer”. In this case a specified area corresponding to the user's behavior and target events the user is interested in (Kyoto is selected as being a place noted for cherry blossoms blooming from now on) is determined, and a target event heat map showing distribution of target events within the specified area is acquired, but in a case where there is no current target event heat map that meets the user's needs, a database showing chronological change of heat maps cannot be referenced. In this case, a user guide method may be used that has steps to convey the fact that it is not possible to estimate conditions for target events at a point in time after a specified time point to the user.

That is, after acquisition of a reference target event heat map, besides searching a current event database, a separate database is acquired, and after that determination as to whether conditions presenting a heat map matching a specified time point currently exist is performed, and a specified area corresponding to the user's behavior and target events the user is interested in is determined. A database showing chronological change in a heat map for the specified area is then referenced to determine whether or not to acquire a reference target event heat map that shows distribution of target events within the specified area at a point in time that is close to the current time. If the result of determination is that acquisition is not possible, it becomes possible to provide a user guide method that can output information showing that it is not possible to estimate conditions of target events at a point in time after a specified time point.

Although it is possible to perform guidance display for recommended cherry blossom blooming courses on April 5th, for the period from April 12th to April 19th, based on heat map images in this way, there are no heat map images that have continuity (similarity) for April 26th and afterwards, and guidance display is not possible. On the other hand, although it is possible to perform guidance display for the period from April 12th to April 26th, based on heat map images, there are no heat map images that have continuity (similarity) for before April 5th, and guidance display for recommended cherry blossom viewing courses is not possible.

It is therefore not possible to perform prediction for a period in which continuous (similar) heat map images are not stored. From a different viewpoint, in Kyoto it is possible to perform prediction based on heat map images after April 12th (providing a guide for this type of condition has been described previously), while in Yokohama prediction is possible up to April 19th. Specifically, time series correlation judgment of this embodiment can be said to be determination of prediction limits. As well as technology that can determine up to where the limits of prediction using a heat map are, a DB is created using the prediction limits, and a guide that is useful to the user is provided.

Next, operation of user advice will be described using the flowchart shown in FIG. 9. This flow is executed by a processor, such as a CPU, controlling each section within the control section 1 in accordance with a program that has been stored in memory within the control section 1.

The flow for user advice shown in FIG. 9 provides advice to a user using a database (determination results output section DB1d) that was created by executing the flows of FIG. 6 or FIG. 7. Specifically, in the flows of FIG. 6 or FIG. 7, a specified area corresponding to user behavior and target event the user is interested in is determined, a target event heat map showing distribution of target events within the specified area at a specified point in time is acquired, and a database that shows chronological change of heat maps of similar areas to the target event heat map is created. The flow shown in FIG. 9 displays a user guide for estimating conditions of target events at a point in time that is after a specified time, by referencing the database that has been created.

If the flow for user advice shown in FIG. 9 is commenced, first, user behavior is determined (S21). The control section 1 is input with position of the user that has been received from each of the mobile terminals of the terminal group 2a (including date and time information), and text data etc. that has been posted to SNS and the like. The control section 1 performs determination as to what the user is currently doing, and how the user will behave in the future, based on these items of information. For example, it is predicted what the user will want to be doing M days later. There may also be cases where the user requests guide information to the control section 1 from the user terminal 4 by means of the guide section 3. In this case, a user request is recognized in this step S21.

Also, a specified area corresponding to user behavior and target event the user is interested in is determined in step S21. For example, if there is a cameraman living in Kyoto, as subjects popular natural beauty spots and social events are target events of interest, and areas corresponding to route maps of the Keihanshin region constitute specified areas. Also, in a case where people are traveling on business every day or periodically within the metropolitan area, then railway lines used, and routes and congestion conditions relating to those lines, constitute target events of interest, and a specified area may be selected such as an area corresponding to routes within the metropolitan area.

Also, if a specified area has been determined in step S21, a reference target event heat map for within that specified area is acquired. Accordingly, in step S21 reference areas in accordance with user behavior and target events the user is interested in are determined, and a reference target event heat map showing distribution of target events within the reference area for specified time is acquired. Acquisition of a reference event heat map may also be performed in the following steps S23 and S25 if a guide for M days later becomes necessary.

If user behavior has been determined, next, it is determined whether or not a guide for M days later is necessary (S23). Here, the control section 1 determines whether or not a guide for the future (M days later, or may be modified to M hours later, as was described earlier) is required, based on result of determination in step S21. For example, whether or not the user is thinking of what they want to be doing M days later, is determined based on result of determination in step S21. There may be cases where the user has posted a plan for M days later on SNS etc., and determination may be based on this type of post. If the result of this determination is that there is no particular plan, and that a guide is not necessary, processing returns to step S21 as unnecessary guides would be wasteful. Obviously it is not necessary to determine M days afterwards, and all information of a range in which the future is known may be presented. However, for the purpose of simplification recommendations for weekend shooting spots, and congestion information at the time of a business trip, for example, within the city, has been assumed.

On the other hand, if the result of determination in step S23 is that a guide is necessary, the event prediction DB is searched (S25). Here, the control section 1 retrieves heat map images corresponding to a guide that was made necessary in step S23, from within the event prediction DB (determination results output section DB 1d).

Once event prediction DB retrieval has been performed, it is next determined whether or not prediction for M days after is possible (S27). Here, the control section 1 performs determination based on whether or not it is possible to predict for M days later, in the event prediction DB that was searched in step S25. As was described previously, if heat map images etc. that are stored in the event prediction DB are continuous over N days, prediction is possible if M days is within this range of N days. Since various heat map images are stored in the event prediction DB as well as heat maps for cherry blossom viewing that were described previously, heat map images that are useful for guidance for M days later are retrieved from amongst these images.

Determination as to whether or not prediction for M days later is possible in step S27 has been described using heat map images for cherry blossom blooming that were described using FIG. 8 as the event prediction DB. With this example, since there are heat map images for the period from April 5th to April 19th (this period corresponds to the period of N days described previously) in Yokohama, if M days after is within this period prediction is possible, but in the case of a date being after April 19th prediction will not be possible. Also, since there are heat map images for the period from April 12th to April 29th (this period corresponds to the period of N days described previously) in Kyoto, if M days after is within this period prediction is possible, but in the case of a there being no heat map images after April 5th prediction will not be possible. If the result of this determination is that M days after cannot be predicted, predicted guidance is not currently effective, and so processing returns to step S21. In this case indication that predicted guidance is not currently effective may be displayed.

If the result of determination in step S27 is that prediction for M days after is possible, what the user requires is displayed based on a prediction result (S29). Advice information such as heat map images for user needs that have been determined in step S21 are transmitted by means of the guide section 3 to the user terminal 4 so that they can be displayed on the user terminal 4. The user can be notified of areas in which cherry blossoms are blooming, and recommended routes for touring around these areas, as shown in FIG. 5 and FIG. 8. If the advice information for display has been transmitted, processing returns to step S21.

In this way, with the flow for user advice, user behavior is determined, and in a case where it is predicted that there will be some activity M days later events that are suitable for guiding M days afterwards are retrieved from the event prediction DB, and it is possible to display a guide based on the results of this retrieval. It should be noted that as the behavior determination in step S21, it may be determined whether or not the user has requested a guide for M days later to the control section 1 using the user terminal 4.

Next, operation for specific event selection from user behavior will be described using the flowchart shown in FIG. 10A. With the example shown in FIG. 9, if user behavior has been determined and a guide for M days later is required, a guide that fits with the user's needs from within a previously created event prediction DB is displayed. The flowchart shown in FIG. 10A is more specific than the flow of FIG. 9, and in this flow user behavior is analyzed, a chronological change correlation DB that is appropriate to the user's tastes etc. is created based on the result of this analysis, and guidance display is performed based on this DB. This flow is also executed by a processor, such as a CPU, controlling each section within the control section 1 in accordance with a program that has been stored in memory within the control section 1.

If the flow shown in FIG. 10A is commenced, first, SNS storage for the previous year, and most recent plans, are retrieved (S31). Here, the control section 1 retrieves text data that a specified user has posted on SNS services, and latest plans etc. that they have described on blogs etc. If the user has written a schedule table into the control section 1, that information is also referenced.

Next it is determined whether images have been uploaded, and whether or not there is a diary, health information etc. (S33). Here, the control section 1 determines whether or the specified user has uploaded images to the internet such as SNS sites etc. Also, since there are also cases where the specified user has uploaded a diary and health information to the Internet, the control section 1 retrieves these items of information. If the result of this determination is that this information could not be retrieved, processing returns to step S31.

If the result of determination in step S33 is that it was possible to retrieve information, then next, likes and dislikes are determined (S35). Here, the control section 1 determines likes and dislikes of the specified user based on information about SNS storage and images etc. that was retrieved in steps S31 and S33. Information relating the user's likes and dislikes may be obtained from history information that stores user behavior, or from history information storing relationships between health parameters and environment. In the case of providing guide information, then obviously the fact that the user likes certain things is displayed, but conversely things that the user does not like may be prevented from being displayed.

Once the likes and dislikes have been determined, creation of a chronological change correlation DB with associated information is next requested (S37). Since what the specified user likes and does not like is determined in step S35, taking this into consideration the chronological correlation determination section 1c determines chronological correlation using a heat map that has been acquired by the event heat map acquisition section 1a of the control section 1 and arranged by the time-series arrangement section 1b, and this chronological correlation data is created. It should be noted that in a case where the chronological correlation determination section 1c is not provided within the control section 1, creation of chronological correlation data may be requested to a chronological correlation determination section within an external server or the like.

Next, it is determined whether or not it was possible to acquire a DB capable of predicting M days later (S39). Here, the control section 1 determines whether or not it is possible to predict M days later using the chronological change correlation DB that was requested in step S37. As was described using FIG. 8, with the chronological change correlation DB there are cases where establishing correlation relationships is for a specified period (over N days). In this step therefore, the control section 1 determines whether or not M days is within the range of N days, and whether or not it is possible to predict M days later, using the chronological change correlation DB that has been created. If the result of this determination is that prediction is not possible, processing returns to step S31.

On the other hand, if the result of determination in step S39 is that a DB capable of predicting M days later has been acquired, guide information is displayed (S41). Here, the control section 1 creates a guide for M days later in line with the tastes of the specified user, using the chronological change correlation DB that was acquired as a result of the request in step S37, and transmits this guide to the user terminal 4 and displays it. Once display has been performed, processing returns to step S31.

FIG. 10B and FIG. 10C show an example of selecting a specified event from user behavior. FIG. 10B is an image that has been uploaded to the Internet by a specified user using SNS etc. This image is a photograph taken for the purpose of remembering an event, and has a motorbike under a cherry tree in full bloom. As will be understood from this image, this user has a high preference for cherry blossoms and motorbikes.

In a case where a lot of images that are similar to FIG. 10B have been uploaded to the Internet, the control section 1 determines that the user has a high preference for cherry blossoms and motorbikes based on these images (refer to S33 and S35 in FIG. 10A). Once the user's preferences are known, the control section 1 creates a chronological change correlation DB based on these preferences. When creating this DB, the event heat map acquisition section 1a collects information in an area suitable for motorbike touring that was selected using map information and word of mouth, or was selected using conditions such as ease of access for that user, and that relates to cherry blossom blooming conditions, and, after this information has been arranged by the time-series arrangement section 1b, the chronological correlation determination section 1c creates a chronological change correlation DB (refer to S37 in FIG. 10A).

If the chronological change correlation DB has been created, guide information for M days after can be displayed to the user. With guidance display, if it is M days later a touring course is introduced on which it is possible to see cherry blossoms in full bloom. In this case, if locations where it is possible to travel by bike, and stop locations, in map information are added to the conditions, then compared to a full bloom cherry blossom guide it becomes an example that has been customized to that user's preferences. Here, an example has been given of a motorcycle rider, but it is also possible to improve the degree of user satisfaction with the same approach for actions when traveling as a family. Further, it is possible to improve degree of satisfaction for a guide by adding information on the age structure of a family, whether or not they have pets, and whether or not those pets are being taken along on the trip.

Also, FIG. 10C is a graph showing body condition change of other specified users. The horizontal axis of this graph is time (years and months), and the vertical axis is a parameter showing body condition. The body condition parameter can use various items such as, for example, body temperature, heart rate, perspiration rate, frequency of sneezing per unit time, nasal mucus amount, itchy eyes etc. Looking at this graph, since sneezing etc. is much more prominent in a period with pollen than at other periods, it can be predicted that this user will suffer from hay fever. It is considered that this type of user would be grateful for display of guidance urging them not to be at locations where there will often be a lot of pollen.

Here, the body condition parameter of the graph has chosen season, but besides this, in the case of allergies such as to dust etc., it is preferable to have a graph display so that it is possible to differentiate positions, whether or not the situation is in a dust-covered room, or along a major road where there are a lot of exhaust fumes etc. In this way, places that it is best for that person to avoid are known. Besides this, since there are people whose body condition changes with pressure (distribution) or temperature, those type of people may proceed with health resort therapy. Also, parameters change in accordance with health conditions, symptoms and body composition of that person. In order to differentiate these various body compositions, a few body condition parameters and other parameters are prepared, and it may be made possible to discriminate from various perspectives.

If it is possible to acquire health information such as shown in FIG. 10C, the control section 1 determines possibility of that user suffering from hay fever based on this graph (refer to S33 and S35 in FIG. 10A). If body condition of the user is known, the control section 1 collects heat map images relating to hay fever, and creates a chronological change correlation DB based on these images. In creating this DB, the event heat map acquisition section 1a collects data relating to hay fever that has been posted on SNS etc., and after arranging using chronological information by the time-series arrangement section 1b the chronological correlation determination section 1c creates the chronological change correlation DB (refer to S37 in FIG. 10A). If the chronological change correlation DB has been created, guide information for M days after can be displayed to the user. With guide display it is likely that there will be an outbreak of hay fever M days later, and so a guide is produced to advise on wearing of a mask, and taking of preventative medicine. Among various types of hay fever, in the event of cedar pollinosis advice may be given to notify of areas in which there are many people suffering from cedar pollinosis. This type of approach is not limited to cedar pollinosis, and if factors causing allergies are known, areas in which these factors are occurring and areas in which they are not occurring may be notified.

In the case of infections, there are also cases where, depending on age and body condition, some people may be affected worse than others. If a congested region has been determined, as in this practical example, then when going to a congested region it is possible to prevent deterioration in body condition by performing circumspect actions, such as having a mask, having disinfectant, washing hands, maintaining social distancing, and putting out guidance etc. With infections also, since there are people who do not exhibit symptoms, similarly, if guidance is displayed to these people also it will be possible to prevent spread of infection and disruption of the medical system.

In this way, user behavior and target events the user is interested in can be determined using history information that records user behavior (for example, subjects of images that have been taken and previous comments on SNS etc.), or history information (for example, information enabling analysis of whether there have been changes in environmental factors (air temperature, air pressure, dust, pollen, weather, or changes in these items)) recording health parameters (for example, biometric information such as coughs, sneezes, fever, sweating, pulse rate, blood pressure, etc., or characteristics of change in these items). Target events may also be determined using current movement direction. Also, a reference area corresponding to user behavior and target events the user is interested in includes areas determined using range in which this user will be doing activities from now on (this may be movement direction from current position, referencing an IC card or ticket that is used in traffic systems, or manual input by the user), or an activity range that has been obtained from history information of user behavior. Range of areas may conform to map information that can be easily obtained, such as tourist maps and route maps.

In this way, with this embodiment, user behavior is analyzed using information that has been posted on the Internet by the user using SNS etc., a chronological change correlation database is created based on the results of this analysis, and information that will be required by this user M days later is acquired from the database and displayed on the user terminal 4. As a result it is possible to predict change in information and provide guide information in order to support user activities. Also, since a chronological correlation database is created taking into consideration not only things the user likes but also things they do not like, things the user dislikes can be displayed. It should be noted that with this embodiment information that has been posted on the Internet etc. is retrieved, but user behavior may also be analyzed at the time that the user posts items.

Next, determination of chronological correlation using AI (artificial intelligence) will be described using FIG. 11A and FIG. 11B. The chronological correlation determination section 1c may obtain chronological correlation of heat map images using an inference model that has been generated by means of machine learning such as deep learning.

Here deep learning will be described simply. “Deep Learning” involves making processes of “machine learning” using a neural network into a multilayer structure. This can be exemplified by a “feedforward neural network” that performs determination by feeding information forward. The simplest example of a feedforward neural network should have three layers, namely an input layer constituted by neurons numbering N1, an intermediate later constituted by neurons numbering N2 provided as a parameter, and an output later constituted by neurons numbering N3 corresponding to a number of classes to be determined. Each of the neurons of the input layer and intermediate layer, and of the intermediate layer and the output layer, are respectively connected with a connection weight, and the intermediate layer and the output layer can easily form a logic gate by having a bias value added.

While a neural network may have three layers if simple determination is performed, by increasing the number of intermediate layers it becomes possible to also learn ways of combining a plurality of feature weights in processes of machine learning. In recent years, neural networks of from 9 layers to 15 layers have become practical from the perspective of time taken for learning, determination accuracy, and energy consumption. Also, processing called “convolution” is performed to reduce image feature amount, and it is possible to utilize a “convolution type neural network” that operates with minimal processing and has strong pattern recognition. It is also possible to utilize a “recursive neural network” (fully connected recurrent neural network) that handles more complicated information, and with which information flows bidirectionally in response to information analysis that changes implication depending on order and sequence.

In order to realize these techniques, it is possible to use conventional general purpose computational processing circuits, such as a CPU or FPGA (Field Programmable Gate Array). However, this is not limiting, and since a lot of processing of a neural network is matrix multiplication, it is also possible to use a processor called a GPU (Graphic Processing Unit) or a Tensor Processing Unit (TPU) that are specific to matrix calculations. In recent years a “neural network processing unit” (NPU) for this type of artificial intelligence (AI) dedicated hardware has been designed to be capable being integratedly incorporated together with other circuits such as a CPU, and there are also cases where they constitute some parts of processing circuits.

Besides this, as methods for machine learning there are, for example, methods called support vector machines, and support vector regression. Learning here is also to calculate discrimination circuit weights, filter coefficients, and offsets, and besides this, is also a method that uses logistic regression processing. In a case where something is determined in a machine, it is necessary for a human being to teach how determination is made to the machine. With this embodiment, determination of an image adopts a method of performing calculation using machine learning, and besides this may also use a rule-based method that accommodates rules that a human being has experimentally and heuristically acquired.

FIG. 11A shows a process for generating an inference model using deep learning, and a process for performing inference using the inference model. In FIG. 11A, the part above the dot and dash line shows appearance of generating an inference model using an inference engine 11 while the part below the dot and dash line shows appearance of inference using the inference engine 11.

Intermediate layers (neurons) 11b are arranged within the inference engine 11, between an input layer 11a and an output layer 11c. Input images 11np, that are inference objects, are input to the input layer 11a. A number of neurons are arranged as intermediate layers 11b. The number of neuron layers is appropriately determined according to the design, and a number of neurons in each layer is also determined appropriately in accordance with the design. Also, training data for at the time of deep learning are data that should be output as learning results when input images 11np have been input. For example, in the case of heat map images showing cherry blossom blooming conditions, annotations AN1 to AN3 indicating areas where blossom are in full bloom etc., and number of posts, are applied. If deep learning is repeated and input images 11np are input, a weighting is applied between each neuron so that an area indicating training data AN is output. Also, when repeating deep learning reliability is calculated, with low reliability images ANlow being excluded (refer to images ANlow in FIG. 11A) to generate a high reliability inference model.

The inference engine 11 functions as an inference engine that learns time series change information of big data that has been acquired, and generates an inference model for providing guide information to a user. The inference engine generates an inference model, before receiving a request to provide guide information from a user, by learning areas of high correlation with big data, on a map within a specified area. The inference engine performs annotation of target events on a map within a specified area, makes training data with this map that has been subjected to annotation as image information, and performs learning using this training data.

An inference model that has been generated by the inference engine 11 is provided in the inference engine 11A shown below the dot and dash line in FIG. 11A. Specifically, the intermediate layers 11 of the inference engine 11A are weighted based on the inference model that has been generated by the inference engine 11. Input images 11np that are determination objects for chronological correlation are input to the input layer 11aa of the inference engine 11A, inference is performed by the inference model that has been provided in the intermediate layers 11ba, and output images Iout are output from the output layer 11ca. This output image HMIout is, for example, an image indicating area ANo where cherry blossoms are in full bloom.

FIG. 11B shows an example for a case where besides a cherry blossom input image I-c, a plum blossom input image I-p and an input image for two years previous have been input. Also, for respective input images, data that has been subjected to annotation is made training data AN-c, AN-p and AN-2. Deep learning is performed in the inference engine 11 using these training data, and an inference model is generated. It should be noted that the input images I-c, I-p and I-2, and the training data AN-c, AN-p, AN-2 are made time series data for different times.

Similarly to FIG. 11A, the inference engine 11A shown below the dot and dash line in FIG. 11B is provided with the inference model that has been generated by the inference engine 11. If an image for two years before or the like is input to the input layer 11aa, inference is performed using the inference model, and output image Iout is output from the output layer 11ca. This inference model is generated using training data AN-c, A-p and AN-2 for different times, which means that images that have taken into consideration time difference are output.

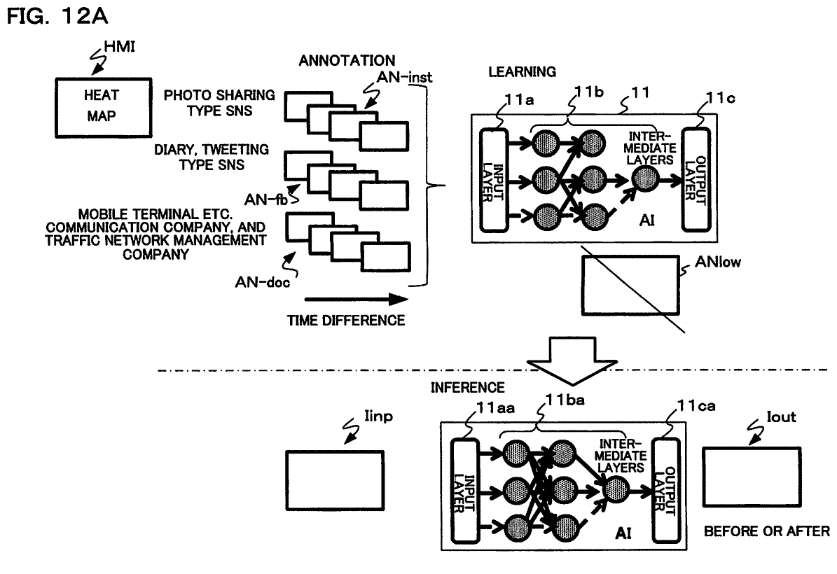

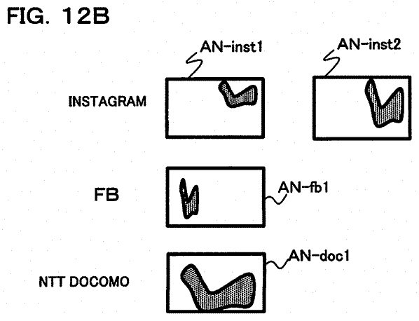

Next, an example that uses heat map image HMI as an input image will be shown using FIG. 12A and FIG. 12B. Heat map image HMI is created from data that has been posted to Instagram that provides a photo sharing social networking service, data that has been posted to Facebook (FB) that is a social networking service, and data that has been posted to NTT Docomo that provides wireless communication services for mobile phones. Positions of areas in which cherry blossoms are in full bloom are annotated in data shown in FIG. 12A, to create training data AN-ins, ANfb, and ANdoc, and used at the time of deep learning in the inference engine 11. The structure of the inference engine 11 and method of deep learning are the same as in FIG. 11A, and the method of inference using the inference engine 11A is also the same as FIG. 11A, and detailed description will be omitted.

FIG. 12B shows heat map images HMO divided into sub categories corresponding to data sources such as respective photo sharing type SNS, diary and tweeting type SNS, portable communication terminal companies and traffic network management companies etc., and creation of time series data with the same sub category. In FIG. 12B, areas are annotated on respective images, and shown as training data. Time series data is created for each sub category, and deep learning is performed by the inference engine 11 using this time series data to generate an inference model.

By arranging the inference engine 11A in the chronological correlation determination section 1c in this way and inputting heat map images that have been arranged in time series, it is possible to determine chronological correlation. For example, by inputting heat map images showing cherry blossom blooming conditions to the inference engine 11A, it is possible to simply detect areas that are similar. Also, since there is classification for every subcategory, and correlation calculation is performed using time series data for respective subcategories, it is possible to improve reliability compared to when performing correlation calculation with all data mixed up.

Also, for data each information collection source, it is possible to have predetermined rules in accordance with data collection contracts and regulations that respective listed companies and related service organizations have with users or between businesses and organizations, which means that it is easy to collect a lot of data in real time. Further, by managing profiles of users that use these services etc., there is the advantages of it being easy to determine by dividing into specified profiles and preferred user behavior. Also, for each information collection source there are certain characteristics, being gender and age compositions of users, which is also useful in classification by users. With user classification it is possible to extract only necessary data, and highly precise analysis and inference becomes possible with noise components removed.

Also, since data for every information collection source has a complementary relationship, analysis (here, correlation determination for convergence over time, heat map movement prediction etc.) may be performed by appropriate selection and complementing. For example, text-based information sources are better for making it possible to retrieve natural language from comparatively light data. Also, regarding what specific conditions there are, easier to understand information is provided with information from photo type services. Also, without conscious posts and the like, gathering large amounts of information is more possible with information from communications companies for which reactions of base stations etc. change only with movement, and information of traffic system type electronic money cards for knowing information on station usage, shop usage and traffic system usage.

Next, operation of chronological change correlation learning using AI will be described using the flowchart shown in FIG. 13. As was described using FIG. 11A to FIG. 12B, this flow performs generation of an inference model using deep learning, and obtains chronological change correlation of heat map images using this inference model. In order to execute this flow, the chronological correlation determination section 1c that was shown in FIG. 4 has inference engines 11 and 11A. It should be noted that generation by the inference engine may also be requested to an external inference engine. This flow is executed by a processor, such as a CPU, controlling each section within the control section 1 in accordance with a program that has been stored in memory within the control section 1.

If the flow for chronological change correlation learning shown in FIG. 13 is commenced, first, specified condition heat map images are acquired (S51). Here, the control section 1 acquires heat map images for the purpose of performing chronological change correlation learning. As specified conditions, specified conditions shown on a map (shown on heat map images, for example) that should be considered by the user are assumed, as shown, for example, in the map M3 of FIG. 4 and the map M14 in FIG. 5. These specified conditions may show events for which a specified guide should be produced, such as conditions where congestion occurs on transport system and stations that will be used from now on, and conditions that can introduce a suitable sight-seeing route to that user with cherry blossom blooming conditions, etc. With only information on areas that should be considered, there will be cases where sufficient previous data cannot be obtained, and so in that case areas having a similar environment may be considered (a case of ●● airport is a new airport, and considering previous data of ΔΔ airport that has a similar design). In this way information on a plurality of areas may be collected and analyzed.

The purpose of heat map images is to investigate chronological change, and so they are a plurality of images for different times. A group of images for calculating correlation relationships, does not want to be images that are dissimilar such that calculating correlation has no meaning at all, and are preferably similar to the extent that correlation can be calculated.

If specified heat map images have been acquired, next, heat maps for the same location as respective specified conditions heat map (images) but N days before are acquired (S53). Here, the control section 1 acquires heat map images at the same locations as heat maps for specified conditions that were acquired in step S51, and that are for N days before. It should be noted that there may be cases where there is no data for the same location, and in this case data for a plurality of areas may be used. For example, since ●● airport is a new airport, there is data for up to one year before, but in a case where there is no data before that heat map, change for that airport up to one year before is used. Also, in a case where there is data for up to 10 years before for 00 airport of a similar design, for the period from 1 year before to 10 years before analysis may be of heat map change for 00 airport. Also, if there is a restriction to the same place, sufficient training data cannot be obtained, and so data for locations having a similar environment may be used. As places with a similar environment, similarities of information on at least one among, for example, if there is a wide place, similar topology and latitude, or in the case of an artificial environment the width, height, and volume of a space in which objects exist, movement trend of objects such as people, and density of those people, and air conditioning, such as for temperature, humidity, and degree of ventilation for that artificial environment, etc. should be compared and selected.

If heat map images have been acquired in step S53, an inference model is generated with respective images, and reliability of this inference model is determined (S55). Here, the inference engine 11 generates an inference model using specified heat map images that were acquired in step S51, and heat map images for N days before that were acquired in step S53. That is, it is possible to increase number of training data if heat map images are acquired in step S53. Annotation for N days before is performed on a heat map for N days before, with an increased number of heat map images as training data, and an inference model so as to be able to infer a specified heat map is generated with information such as a heat map for N days before and N days, while determining whether it is possible to infer a specified heat map image correctly.

If an inference model has been generated in step S55, reliability of this inference model is determined. Specifically, reliability of this inference model is determined by whether a correct heat map for N days later has been inferred, using specified test data that was used in previous examples. Also, when determining reliability, data for evaluation is prepared, for example, this data for evaluation is input to the inference model, and determination of reliability may be performed based on the output result.

In this step S55, “heat map prediction for 1 day later”, “heat map prediction for 2 days later”, . . . , and inference models may be successively generated. In this case, if “N days” is input, a heat map for N days later is inferred with N as a variable, and an approach may be taken of being able to present this heat map that has been inferred. If a heat map is predicted using the inference model, for example, if a current heat map is input, it is possible to present a future heat map for an arbitrary time etc., and it becomes possible to give guidance using a method other than referencing with a chronological change DB that has already been described. Also, if an inference result that has been obtained with input of the current heat map is dropped into a DB, it is possible to create a chronological change DB such as has already been described.

If the result of determination in step S57 is that reliability is high, N days is changed to another number of days (S59). Here, the day for heat map images that are acquired in step S53 is changed by the control section 1. If N days has been changed, heat map images for N days before are acquired in step S53, an inference model is created, and reliability of this inference model is determined. By repeating this operation, correlation between specified heat map images and heat map images becomes high, and reliability becomes high.

If the result of determination in step S57 is that reliability is not high, N days where reliability is high is decided, and a time difference between heat maps is set in the DB (S65). In step S57, a database is created using heat map images for N days before for which it was determined that reliability is high. In the case where there are a plurality of heat images for which reliability has been determined to be high, a database that is constituted by heat map image groups having time differences, in accordance with creation time of respective images, is created. A DB for event prediction (chronological correlation DB) such as shown in FIG. 5 and FIG. 8, for example, is generated by storing this plurality of heat map images for different times. Once the database has been created, this flow is terminated.

Next, a modified example of operation of chronological change correlation learning will be described using the flowchart shown in FIG. 14. With the flow for chronological change correlation learning that was shown in FIG. 13, if reliability of an inference model was low generation of an inference model was terminated at that point in time. Conversely, with the flow shown in FIG. 14, after generation of an inference model for day Np has been completed, if reliability for M days before is low then heat map images for that day are excluded from training data and an inference model is generated again (refer to, in particular, S58 Yes, and S61 and S63). Comparing the flow of FIG. 14 with the flow of FIG. 13, they differ in that step S57 is changed to S58, and steps S61 and S63 are added. Description will focus on this difference.

It should be noted that the training data that has been excluded is collected, and in cases where other conditions are also considered and that information exhibits the same conditions, training data groups and test data may be reformed using those conditions, and inference for specified conditions performed. In this case, two approaches to inference become possible, namely general inference and under special conditions, and at a time when conditions are aligned there is further customization and high precision inference becomes possible.

If the flow for chronological change correlation learning of FIG. 14 is commenced, specified heat map images are first acquired (S51), then a heat map for N days before at the same locations as the respective specified condition heat maps are acquired (S53), respective inference models are then created, and reliability is determined (S55). Once reliability has been determined, it is next determined whether or not inference models have been created for Np days (S58). The processing of previously described steps S51 to S55 is performed over predetermined Np days, and so the control section 1 determines whether or not processing has been completed for Np days. It should be noted that similarly to step S7 in FIG. 6, day Np may be appropriately set taking into consideration properties of a database that is generated, range of data that can be collected by the event heat map acquisition section 1a etc.

If the result of determination in step S58 is that the processing has not been completed for Np Days, day N is changed (S59) and processing returns to S53. Inference models are generated by repeating from step S53 to S58 while changing N days in step S59.

If the result of determination in step S58 is that processing for Np days has been completed, it is next determined whether or not a day M days before is low reliability (S61). Here, within determination that was performed in step S55, a day when reliability is lower than a predetermined value is retrieved, and this day on which reliability is low is made M days before. As the predetermined value, a value should be set so that a specified reliability an inference model.

If the result of determination in step S61 is that reliability for M days before is low, the heat map for that day is excluded from training data (S63). A method of effectively using this data that has been excluded has already been described. Not only is data excluded in step S63, control etc. is also performed to store this excluded data in a storage device to be adopted as new training data for other learning. At the time of creating an inference model, annotation is performed on a heat map that has been acquired, and this annotated heat map is used as training data. In a case where reliability of an inference model that was created using a heat map for M days before is low, it would be better not to use this training data when creating an inference model. This heat map for M days before is therefore excluded, and preferably an inference model is used again. For example, it is also possible that there will be cases where reliability is low for heat maps of years of abnormal weather, heat maps for days of heavy rain, heat maps for days of driving snow, etc. There may also be cases where reliability is also low on days when events where a lot of people gather are held. Because of this reliability may also be determined using information on weather and events. In step S63, if training data has been excluded processing returns to S51, and an inference model is generated with a heat map for M days before excluded.

If the result of determination in step S61 is that reliability is not low, N days having high reliability is decided upon, and a database (DB) is created by storing, including time difference between heat map images (S65). Once a DB has been created the flow for chronological change correlation learning is terminated.

In this way, in the flow for chronological change correlation learning shown in FIG. 14, if generation of an inference model using data for Np days is completed, heat maps having a low reliability are removed from training data and an inference model is generated again. This means that it is possible to generate an inference model of high reliability.

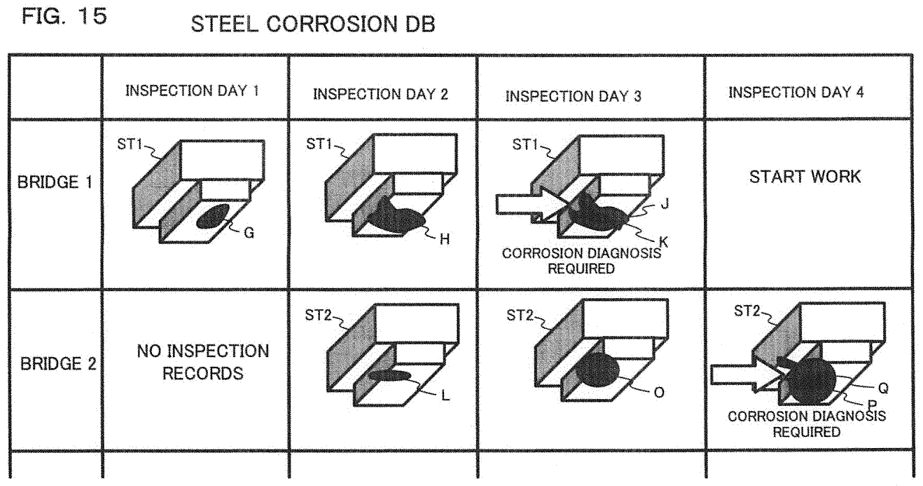

Next, a description will be given of an example where this embodiment has been applied to a reinforcement corrosion database, using an event prediction database (DB) shown in FIG. 15. Internal steel is embedded within a concrete structure such as a bridge. Since corrosion in reinforcing steel will advance if neglected, in order to maintain the value of a concrete structure over a long time period it is desirable to accurately ascertain the corrosion rate of steel reinforcements supporting this building, and carry out planned repairs. Corrosion will be aggravated if there is neglect, and as a result significant repairs costs will be incurred. However, judgment of when to perform corrosion diagnosis is not a simple matter, because it will involve work in high and narrow locations. For this reason, concrete structures with steel reinforcement embedded in them are inspected from outside, and timing for corrosion diagnosis and repair is therefore predicted using chronological change correlation of the results of this inspection (heat map images).

FIG. 15 shows results of inspections that were respectively performed on inspection day 1 to inspection day 2, for bridge 1 and bridge 2. This inspection is, for example, a hammering test, and may be a three dimensional hammering test or a two dimensional hammering test. In FIG. 15 inspection results are shown as two-dimensional and three-dimensional heat maps, so that for a structure ST1 of bridge 1 and structure ST2 of bridge 2, with a hammering test for every inspection day differences in acoustic echo at the time of hammering will be known.

Looking at bridge 1, echo for area G on inspection day 1 is different to other areas, echo for area H on inspection day 1 is different to other areas, and echoes of areas J and K on inspection day 3 are different to other areas. Inspection results for each of these inspection days are made heat map images. If chronological change correlations between these heat map images and heat map images at the time when corrosion diagnosis becomes necessary are determined, a time period required for corrosion diagnosis, and time for performing repair work for the purpose of corrosion prevention, can be predicted. By determining chronological change correlations for heat map images for inspection days 1 and 2 for bridge 1, it is possible to predict that corrosion diagnosis will be required on inspection day 3, and it is possible to predict that it will be necessary to commence repair work on inspection day 4.

For bridge 2 there is no inspection record for inspection day 1, while area L on inspection day 2, area 0 on inspection day 3, and echoes of areas P and Q on inspection day 4 are different to other areas. By determining chronological change correlations for heat map images for these inspection days 2 and 3, it is possible to predict that corrosion diagnosis will be necessary on inspection day 4.

In this way, with the example shown in FIG. 15, by acquiring heat map images based on results of hammering test it is possible to predict in advance time when corrosion diagnosis will be required, and time when repair work will be carried out. Specifically, it is possible to estimate repair work quickly, and it is possible to prevent large-scale work due to corrosion.

As has been described above, with one embodiment of the present invention it is possible to provide a user guide method that has steps of determining a reference area in accordance with user behavior and/or target events the user is interested in, and acquiring a reference target event heat map that shows distribution of target events within the reference area at a specified point in time (refer, for example, to S101 in FIG. 2 and S21 in FIG. 9), and steps of referencing the reference target event heat map and a database that shows chronological change of previous heat maps for the same or similar areas, and estimating conditions of target events at a point in time that has passed from the specified point in time (refer, for example, to S111 in FIG. 2, and S29 in FIG. 9). As a result is impossible to predict changes in object information at a specified location, and to assist with user actions.

Also, with one embodiment of the present invention, distribution information of target events within a specified position range that have been acquired in time series is acquired (refer, for example, to S3 in FIG. 6), chronological correlation of distribution information of the target event that has been acquired is determined (refer, for example to S5 in FIG. 6), and guide information is retrieved and displayed using a chronological correlation database that has been obtained using determination results for chronological correlation (refer, for example, to S11 in FIG. 6, and S29 in FIG. 9). As a result it is possible to predict change in information in two dimensional or three dimensional space on a map, or in a specified area, and to assist with user actions.

It should be noted that with one embodiment if the present invention, examples of creating a database relating to cherry blossom blooming conditions and a database relating to corroded condition of reinforcing steel in a bridge etc. have been described as a chronological correlation database creation system. However, this is not limiting and it is possible to create two-dimensional or three-dimensional heat maps, and to apply this embodiment to a model for predicting events from chronological correlation relationships of this heat map. For example, it is also possible to apply this embodiment to a case of predicting degree of congestion of downtown areas etc. It is also possible to perform prediction of inspection days, etc. by determining correlation relationships of change in biotissue such as prostatic carcinoma. It is also possible to make change in temporal conditions in two-dimensional or three-dimensional space, such as prediction of degradation of piping etc. within a factory, prediction of degradation of moving parts of a jet engine or gasoline engine etc., prediction of infection such as pathogenic organisms, colds etc., and prediction of weather, into a heat map, and to predict events from chronological correlation relationships of this heat map.

Also, with one embodiment of the present invention chronological correlation determination was performed for heat map images, and a chronological correlation database was created. However, the objects of correlation determination are not limited to images, and data may also be used. Specifically, even if there are no images themselves, correlation calculation may be performed for associated data. Also, although the chronological correlation database has been described for a case of being created in day units, units are not limited to days, and may be appropriately set to year units, month units, hour units, minute units or second units. For example, collapse prediction for a bridge due to tidal wave or flooding of a river etc. requires precision in units of seconds. Also, with this embodiment, prediction has been performed for Mm days later, but prediction is not limited to being in units of days, and prediction may be appropriately performed in units of years, months, or hours.

Also, in recent years, it has become common to use artificial intelligence, such as being able to determine various evaluation criteria in one go, and it goes without saying that there may be improvements such as unifying each branch etc. of the flowcharts shown in this specification, and this is within the scope of the present invention. Regarding this type of control, as long as it is possible for the user to input whether or not something is good or bad, it is possible to customize the embodiments shown in this application in a way that is suitable to the user by learning the user's preferences.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they be downloaded via the Internet.

Also, with the one embodiment of the present invention, operation of this embodiment was described using flowcharts, but procedures and order may be changed, some steps may be omitted, steps may be added, and further the specific processing content within each step may be altered. It is also possible to suitably combine structural elements from different embodiments.

Also, regarding the operation flow in the patent claims, the specification and the drawings, for the sake of convenience description has been given using words representing sequence, such as “first” and “next”, but at places where it is not particularly described, this does not mean that implementation must be in this order.

As understood by those having ordinary skill in the art, as used in this application, ‘section,’ ‘unit,’ ‘component,’ ‘element,’ ‘module,’ ‘device,’ ‘member,’ ‘mechanism,’ ‘apparatus,’ ‘machine,’ or ‘system’ may be implemented as circuitry, such as integrated circuits, application specific circuits (“ASICs”), field programmable logic arrays (“FPLAs”), etc., and/or software implemented on a processor, such as a microprocessor.

The present invention is not limited to these embodiments, and structural elements may be modified in actual implementation within the scope of the gist of the embodiments. It is also possible form various inventions by suitably combining the plurality structural elements disclosed in the above described embodiments. For example, it is possible to omit some of the structural elements shown in the embodiments. It is also possible to suitably combine structural elements from different embodiments.

What is claimed is:

1. A user guide method, comprising:
determining a reference area according to user behavior and/or target events the user is interested in;
acquiring a reference target event heat map representing distribution of the target events within the reference area for a specified time point; and
estimating conditions of a target event at a time when time has passed from the specified time, by referencing the reference target event heat map, and a database that shows chronological change of previous heat maps for the same or similar areas.

2. The user guide method of claim 1, wherein:
the heat map includes arrangement information of environmental components that exert influence and constraint on chronological change in the target events, such as topography, buildings, and roads, in the reference area.

3. The user guide method of claim 1, wherein:
the user behavior and target events the user is interested in is information that has been obtained from history information recording the user behavior, or history information recording relationships between health parameters and environment, and the reference area corresponding to the user behavior and/or target events the user is interested in is an area determined according to a range of behavior of the user from now on.

4. A guide retrieval device, comprising:
a processor having an acquisition section, a chronological correlation determination section, and a retrieval section, wherein
the acquisition section acquires distribution information of target events within a specified area that has been generated a plurality of different times;
the chronological correlation determination section determines chronological correlations based on time change of patterns of distribution of the target events and/or continuity of trend of movement of a distribution pattern, using distribution information of target events within a specified area that has been acquired by the acquisition section; and
the retrieval section retrieves guide information from a chronological correlation database that was obtained using determination results for the chronological correlation.

5. The guide retrieval device of claim 4, wherein:
a distribution pattern for the target events is represented as a heat map that shows current position and density of objects constituting the target events using two-dimensional patterns and colors; and
the chronological correlation determination section determines chronological correlation in accordance with area, color, and time change of a two-dimensional pattern expressed within a heat map, and continuity of directivity of movement.

6. The guide retrieval device of claim 4, wherein:
the chronological correlation determination section determines chronological correlations based on trend of time change of overlapping of a plurality of patterns of distribution of the target events, using distribution information of target events within a specified area that has been acquired by the acquisition section.

7. The guide retrieval device of claim 4, wherein:
the chronological correlation determination section determines chronological correlation of distribution information of the target events in accordance with distribution information for target events that have been traced back in time, with respect to distribution information of target events corresponding to guide information.

8. The guide retrieval device of claim 4, wherein:
the chronological correlation determination section is capable of classifying target events into a plurality of categories, and determines chronological correlation for each of the respective categories.

9. The guide retrieval device of claim 4, wherein:
the chronological correlation determination section determines chronological correlation in accordance with event information for a specified area, and environment information.

10. The guide retrieval device of claim 4, wherein:
the chronological correlation determination section creates training data by performing annotation of time difference of distribution information of the target events that have been traced back in time, with respect to distribution information of the target events corresponding to the guide information, and determines continuity of the event distribution information based on extent of reliability at the time learning was performed using this training data.

11. The guide retrieval device of claim 4, wherein:
the chronological correlation determination section determines chronological correlation of distribution information of target events depending on whether overlapping of distribution information of target events that have been traced back in time is close to a predetermined specified proportion, for distribution information of target events corresponding to guide information.

12. The guide retrieval device of claim 4, wherein:
the chronological correlation determination section determines the chronological correlation based on similarity of associated distribution information for comparatively close times within a plurality of times.

13. The guide retrieval device of claim 4, wherein:
the retrieval section determines limits of prediction based on the chronological correlation database.

14. The guide retrieval device of claim 13, wherein:
the retrieval section sets a range in which continuity or similarly of distribution information of the target event is maintained, or a range in which reliability of inference results of correlation calculation is higher than a predetermined value, within a range of the prediction.

15. The guide retrieval device of claim 13, wherein:
the acquisition section acquires big data that has appeared on a space within the specified area; and
the guide retrieval device further comprises
an inference engine that learns time series change information of big data that has been acquired, and creates an inference model for providing guide information to a user.

16. The guide retrieval device of claim 15, wherein:
the inference engine generates an inference model, before receiving a request to provide guide information from a user, by learning areas of high correlation big data, on a map within a specified area.

17. The guide retrieval device of claim 15, wherein:
the inference engine performs annotation of target events on a map within a specified area, makes training data with this map that has been subjected to annotation, and performs learning using this training data.

18. The guide retrieval device of claim 4, wherein:
the chronological correlation determination section determines chronological correlation for distribution information of target events, taking into consideration the likes and dislikes of the user.

19. The guide retrieval device of claim 18, wherein:
likes and dislikes of the user are information that is obtained from history information that stores user behavior, or history information that stores relationships between health parameters and environment.

20. A guide retrieval method, comprising:
acquiring distribution information of target events in a specified position range that have been acquired in time series;
determining chronological correlations of distribution information of the target events that have been acquired; and
retrieving guide information from a chronological correlation database that was obtained using determination results for the chronological correlations.
